(19) United States
(12) Patent Application Publication
(10) Pub. No.: US 2024/0302265 A1
(43) Pub. Date: Sep. 12, 2024

(54) LABEL-FREE IMAGE-ENCODED MICROFLUIDIC CELL SORTER WITH A SCANNING HIGH FOCAL DEPTH BEAM

(71) Applicant: THE REGENTS OF THE UNIVERSITY OF CALIFORNIA, Oakland, CA (US)

(72) Inventors: Yu-Hwa Lo, San Diego, CA (US); Xinyu Chen, La Jolla, CA (US); Lauren Waller, San Diego, CA (US); Jiajie Chen, La Jolla, CA (US)

(21) Appl. No.: 18/570,603

(22) PCT Filed: Jun. 16, 2022
(86) PCT No.: PCT/US2022/033770

§ 371 Date: Dec. 14, 2023

Related U.S. Application Data
(60) Provisional application No. 63/211,958, filed on Jun. 17, 2021.

(51) Int. Cl. G01N 15/149; G01N 15/10; G01N 15/1433; G01N 15/1434

(52) U.S. Cl. CPC G01N 15/149; G01N 15/1433; G01N 15/1434; G01N 2015/1006

(57) ABSTRACT

Disclosed are devices, systems and methods for label-free, image-encoded, microfluidics-based cell sorting. In some aspects, an image-based particle sorting system includes an optical imaging system; a data processing system to process the image data obtained by the optical imaging device and determine one or more properties associated with the individual particles flowing in the carrier fluid and to produce a control command based on a comparison of the determined one or more properties with a sorting criteria; and a particle sorting system including a particle flow device that comprises a substrate including the particle-flow channel and a plurality of output channels branching from the particle-flow channel to receive, in one output channel of the plurality of output channels, sorted particles directed by an actuator device based on the control command.

### CROSS-REFERENCE TO RELATED APPLICATIONS

This patent document claims priorities and benefits of U.S. Provisional Application No. 63/211,958, titled “LABEL-FREE IMAGE-ENCODED MICROFLUIDIC CELL SORTER WITH A SCANNING BESSEL BEAM” and filed on Jun. 17, 2021. The entire content of the aforementioned patent application is incorporated by reference as part of the disclosure of this patent document.

### STATEMENT REGARDING FEDERALLY SPONSORED RESEARCH OR DEVELOPMENT

This invention was made with government support under grant DA045460 awarded by the National Institutes of Health. The government has certain rights in the invention.

### TECHNICAL FIELD

This patent document relates to techniques, systems, and devices for flow cytometry.

### BACKGROUND

Flow cytometry is a technique to detect and analyze particles, such as living cells, as they flow through a fluid. For example, a flow cytometer device can be used to characterize physical and biochemical properties of cells and/or biochemical molecules or molecule clusters based on their optical, electrical, acoustic, and/or magnetic responses as they are interrogated by in a serial manner. Typically, flow cytometry uses an external light source to interrogate the particles, from which optical signals are detected caused by one or more interactions between the input light and the particles, such as forward scattering, side scattering, and fluorescence. Properties measured by flow cytometry include a particle's relative size, granularity, and/or fluorescence intensity.

### SUMMARY

Disclosed are devices, systems and methods for label-free, image-encoded, microfluidics-based cell sorting. In some aspects, a label-free image-guided microfluidic cell sorter device, system, and method are disclosed that offers a low-cost, high information content, and disposable solution that overcomes many limitations in conventional cell sorters.

The subject matter described in this patent document can be implemented in specific ways that provide one or more of the following features.

In some aspects, an image-based particle sorting system includes an optical imaging system, including (i) a light source to produce an excitation beam, (ii) an optical shape-forming device to modify a shape of the excitation beam to have an increased focal depth that is to be directed at an interrogation area of a particle-flow channel, (iii) an optical scanning device to scan for one or more light beams at the interrogation area, (iv) one or more spatial filters arranged in an optical path of the directed shape-modified excitation beam, and (v) one or more optical detectors to obtain image data of individual particles flowing in a carrier fluid through the interrogation area of the particle flow device from the one or more scanned light beams; a data processing system comprising at least one processor and at least one memory and in communication with the optical imaging system and configured to process the image data obtained by the optical imaging device to determine one or more properties associated with the individual particles flowing in the carrier fluid and to produce a control command based on a comparison of the determined one or more properties with a sorting criteria, wherein the control command is produced in real time during flowing of the individual particles in the particle-flow channel; and a particle sorting system in communication with the data processing system and disposed in the optical path of the optical imaging system, the particle sorting system including a particle flow device and an actuator device operably coupled to the particle flow device, wherein the particle flow device comprises a substrate including the particle-flow channel and a plurality of output channels branching from the particle-flow channel to receive, in one output channel of the plurality of output channels, sorted particles directed by the actuator device based on the control command.

In some aspects, a method for sorting particles includes modifying a shape of an excitation laser beam generated by a laser light source to produce a shape-modified excitation beam; directing the shape-modified excitation beam at a channel of a particle flow device; obtaining image data of individual particles flowing in a carrier fluid along the channel of the particle flow device by scanning the shape-modified excitation beam directed at the channel; processing the obtained image data to determine one or more properties associated with the individual particles flowing in the carrier fluid; producing a control command based on a comparison of the determined one or more properties with a sorting criteria, wherein the control command is produced in real time during the flowing of the individual particles in the channel; and sorting the individual particles based on the control command into one of a plurality of output directions branching from an input direction of the individual particles.

The disclosed devices, systems, and methods are capable of improving existing image-based particle sorting techniques. For example, flow confinement for most microfluidic devices is generally only one-dimensional using sheath flow. As a result, the equilibrium distribution of cells spreads beyond the focal plane of commonly used Gaussian laser excitation beams, resulting in a large number of blurred images that hinder subsequent cell sorting based on cell image features. To address this issue, the disclosed technology, in some embodiments, includes a Bessel-Gaussian beam image-guided cell sorter platform with an ultra-long depth of focus, enabling focused images of >85% of passing cells. In some example embodiments, a system features label-free sorting capabilities based on features extracted from the output temporal waveform of a photomultiplier tube (PMT) detector. Example implementations of the system were performed for the sorting of polystyrene beads, SKNO1 leukemia cells, and Scenedesmus green algae were performed, which produced example results (discussed herein) that indicate a sorting purity of 97%, 97%, and 98%, respectively, showing that the temporal waveforms from the PMT outputs have strong correlations to cell image features. These correlations are also confirmed by off-line reconstructed cell images from a temporal-spatial transformation algorithm tailored to the scanning Bessel-Gaussian beam.

### BRIEF DESCRIPTION OF THE DRAWINGS

FIG. 1A shows a diagram illustrating an example embodiment of an image-guided, label free cell sorter system in accordance with the present technology.

FIG. 1B shows a block diagram of an example embodiment of a data processing and control unit included in the image-guided, label free cell sorter system of FIG. 1A and other embodiments in accordance with the present technology.

FIGS. 1C and 1D show diagrams illustrating an example embodiment of a Bessel-Gaussian beam image-guided, label free cell sorter in accordance with the system of FIG. 1A and other embodiments in accordance with the present technology.

FIGS. 2A and 2B show an example COMSOL simulation of the electric field when a Bessel-Gaussian beam illuminates on the center of a 7 μm bead (FIG. 2A) and an example transmission image of a 7 μm bead generated by the image-guided cell sorter using a scanning Bessel-Gaussian beam (FIG. 2B).

FIGS. 3A-3C show images depicting a Bessel-Gaussian beam profile.

FIG. 4 shows example in-focus and out-of-focus 15 μm bead and 7 μm bead images generated by the Gaussian beam system.

FIG. 5A shows a flow diagram of an example embodiment of an image reconstruction method for eliminating side lobe energy in a scanned Bessel-Gaussian beam, in accordance with the present technology.

FIG. 5B shows a data plot illustrating an approximated Bessel function, approximated by a series of delta functions at the maxima and minima.

FIGS. 5C and 5D show data plots and images depicting transmission PMT signals for 15 μm and 7 μm beads and reconstructed images.

FIGS. 6A and 6B show images and histograms of polystyrene beads generated by an example embodiment of the Bessel-Gaussian beam image-guided cell sorter.

FIGS. 7A and 7B show data plots and images depicting results of example implementations.

FIGS. 8A-8C show data plots and images depicting results of example implementations.

### DETAILED DESCRIPTION

Disclosed are devices, systems and methods for label-free, image-encoded, microfluidics-based cell sorting. In some aspects, a label-free image-guided microfluidic cell sorter device, system, and method are disclosed that offers a low-cost, high information content, and disposable solution that overcomes many limitations in conventional cell sorters.

Characterization, classification, and isolation of cell types among a heterogenous population based on their morphological characteristics, without staining of such cell populations, can yield significant biological insight, especially when coupled with phenotype-genotype correlation data. However, performing such characterization, classification, and/or isolation of cells can involve complex processes, which using conventional techniques, do not yield results efficiently due to low throughput. Cell classification processes often require both the multiparametric spatial information of intracellular structures and high data volume analysis. In recent years, genome sequencing and population genomic analysis have had a profound impact in biological research by enabling high-volume comparative analysis, enabling new cell type discovery and uncovering previously unknown cellular heterogeneities. This has significantly increased the need for methods capable of isolating cells of interest in a label-free environment to simplify the process flow, reduce cost, minimize cell disruptions by labeling, and overcome limitations of biomarker availability and specificity. Conventional methods of cell sorting include optical microscopy, deterministic lateral displacement, density gradient methods, and fluorescence and magnetic-activated cell sorting (FACS/MACS). However, these techniques suffer from some of the following aspects, including lack of specificity, low throughput, high cell loss, population-based sorting without single cell resolution, and the need for biochemical labeling.

A significant development in the field of label-free cell sorting is described herein for an imaging flow cytometer/cell sorter. The disclosed microfluidic-based technology enables the highly informative morphological and spatial characterization of intracellular structures and subsequent sorting of cells of interest at a throughput of over two hundred cells per second. Various possible configurations of the disclosed label-free, image-encoded microfluidic cell-sorting technique exist, each with unique characteristics and applications ranging from inexpensive, custom laboratory tools to precise clinical instruments, enabling the employment of the disclosed label-free cell sorting techniques at any scale (e.g., small scale applications, such as scientific exploration, to large scale industrial applications, such as drug discovery and development and/or clinical use in personalized medicine). In some example implementations, the disclosed label-free, image-encoded microfluidic cell-sorting technique can be used with compatible on-chip cell sorting techniques, which can include surface acoustic waves (SAWs), magnetic forces, and/or dielectrophoretic forces, and/or with machine learning, artificial intelligence, and/or coupling with downstream microarray-based systems.

Previous work has included an image-guided cell sorter device that includes a fast-scanning laser as the excitation source. As an example, in a simple microfluidic device suitable for low-cost, disposable applications that minimizes cross contamination, one-dimensional flow focusing confines the procession of cells into the center of the microfluidic channel only in one axis perpendicular to the flow direction. However, in the other perpendicular axis, the cell positions are not confined. As a result, particles in the flow channel tend to have a wide distribution in their positions affected by their size, stiffness, shape, and morphology. To extract image related features of high fidelity, keeping the cells at the focal spot of the interrogating beam is essential. Cells positioned outside the focal depth of the interrogating beam will give rise to blurred images. Furthermore, given the typical 10-15 μm cell size, even for the cells located in the focal plane, a significant portion of the cell features can be out of focus.

As a result, image-guided flow cytometer cell sorters using a tightly focused Gaussian beam from a high numerical aperture (NA) objective face two major challenges: (i) to keep cells of different properties in the flow channel all in focus and (ii) to keep all parts of the cells across their thickness along the optical axis in focus. Inability to meet the former requirement gives rise to a large number of out-of-focus cells, resulting in low throughput and biased analysis since some cell subpopulations tend to be in focus more than others. Failure to meet the latter requirement increases the risk of misleading the gating criteria for sorting since the apparent crisp cell image represents only the feature of one cross section of the cell, leaving features outside the focal plane blurry or not detectable.

Disclosed are systems, devices, and methods for label-free, image-encoded, microfluidics-based particle sorting based on imaging techniques to shape the optical excitation beam for increasing the focal depth during flow particle interrogation. In implementations, the disclosed systems, devices, and method can provide a low-cost, high information content, and application-adaptable solution that overcomes many limitations in conventional cell or particle sorters. The disclosed systems, devices, and methods are directed to image-based sorting of various types of particles, including living particles (e.g., cells) and non-living particles; and the present disclosure may discuss any types of particles for the disclosed systems, devices, and methods by way of example.

In some embodiments in accordance with the present technology, an image-guided cell sorter device is modified to include a scanning Bessel beam system with extended focal depth, which can be implemented according to the disclosed label-free, image-encoded microfluidic cell-sorting technique to overcome the above limits and perform image-guided cell sorting in a disposable microfluidic cartridge. In some implementations, for example, the extended focal depth can be at least 60 μm. For example, various embodiments of the image-guided, scanning Bessel beam-based cell sorter device can increase the focal depth of the real-time-imaged particles under flow by 80%-95% increased focus, e.g., compared to conventional Gaussian beam imaging. In various implementations, for example, the sorting criteria can be directly determined from the image-encoded temporal waveform without image restoration. Moreover, such a system is simple to set up and can operate in a label-free manner.

Although not used in a flow cytometer system before, Bessel beam-based illumination microscopy methods can be leveraged to increase the depth of focus in biological specimens with near-isotropic spatial resolution, achieving significant merit in light-sheet microscopy, illumination microscopy, and electron microscopy. A Bessel beam is a diffraction-free mode solution of the Helmholtz equation and possesses a number of unique properties which make it useful for imaging applications, including non-diffractive behavior and the ability to self-heal when partially obstructed. A mathematically ideal Bessel beam cannot exist as it is unbounded and carries an infinite amount of energy. An experimentally achievable approximation is to modulate the Bessel beam by a broad width Gaussian function, which is called a Bessel-Gaussian beam. The most used method of generating the Bessel-Gaussian beam is by illuminating a conically shaped element called an axicon with a Gaussian beam.

Example embodiments of an imaging flow cytometer and cell sorter with an ultra-long depth of focus, i.e., systems, devices, and techniques that shape a laser excitation beam to increase the focal depth for particle interrogation, are demonstrated in this disclosure. For instance, in some embodiments, the focal depth of the laser beam is increased by shaping the laser excitation beam through a conical prism and directed at an interrogation region where objects-of-interest flow, where the laser beam with extended focal length is rapidly scanned by an optical scanning device (e.g., an acousto-optical deflector (AOD)) and images are captured, processed, and analyzed in real time (e.g., to make real-time decisions, such as selecting certain objects from others in a population based on programmable criteria). In this manner, label-free detection of the objects-of-interest in a flow channel is achieved from the images produced by the scanning laser beam and one or more optical detectors (e.g., photomultiplier tubes). Spatial filtering and image processing techniques described herein can be applied to remove detrimental effects of side lobes (energy) typically present in laser beam imaging with extended focal length to produce focused, high-resolution images of the objects-of-interest in real-time implementations. The disclosed techniques are engineered to block (e.g., spatially filter) at least some of the optical energy in the side lobes and algorithmically eliminate remaining side lobe energy to provide the focused, high-resolution images.

In some embodiments, the imaging flow cytometer and cell sorter accomplished by generating a scanning Bessel-Gaussian laser beam at a particle flow sample to be interrogated, where two-dimensional images of the particles (e.g., single, living cells) are reconstructed from one dimensional waveform information, e.g., collected from a photomultiplier tube (PMT). From this waveform, a number of cellular morphological features are quantified, and these values can be used to create appropriate gates for cell sorting. In some embodiments, for example, sorting is accomplished via an integrated piezoelectric (PZT) actuator. The PZT-integrated microfluidic device is made of cyclo-olefin copolymer (COC) material integrated with a cartridge that contains microfluidic channels and interfaces with the fluidic pumps. Both the microfluidic chip and the cartridge are injection molded and can be disposed to eliminate concerns of cross contamination.

Example implementations were conducted to evaluate the sorting performance of the system for multiple sizes of polystyrene beads, label-free identification and sorting of acute myeloid leukemia (AML) cells from white blood cells, and the label-free sorting of Scenedesmus sp., a green algae, from field-collected microorganisms. Example results discussed in this disclosure indicate a sorting accuracy of 97%, 97%, and 98%, respectively. The example results also demonstrate an increased percentage of in-focus cell images from 30-40% for a Gaussian beam system to >85% by using a Bessel-Gaussian beam, e.g., effectively increasing the throughput by about three folds to around 300 cells/second, which is limited by the response of the on-chip piezoelectric actuator and the presence of cell doublets (and therefore the technique is capable of even further increased throughput improvement when using a faster actuator device).

These and other example embodiments are discussed in further detail below.

### Example Embodiments

### A. Design of an Example Imaging System

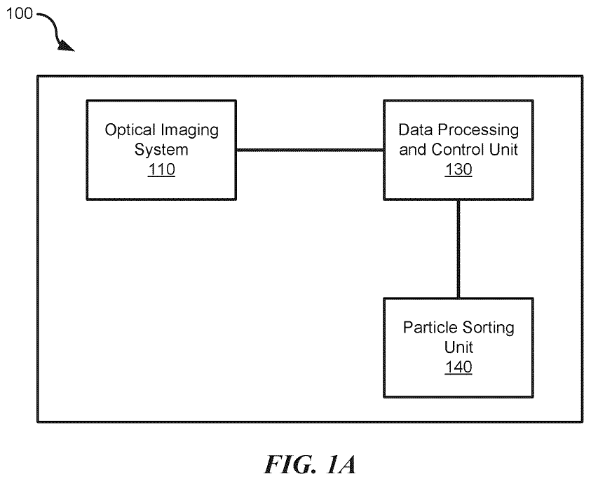

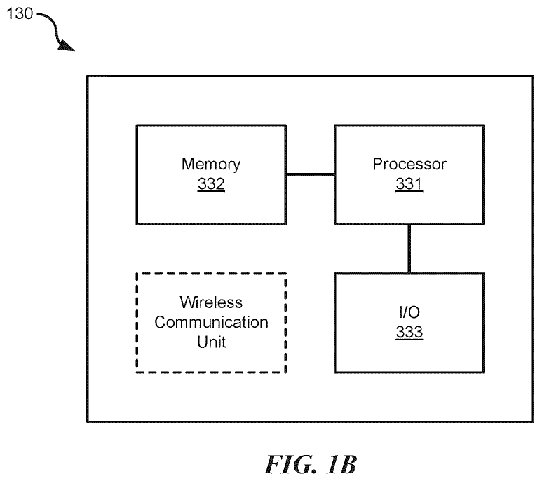

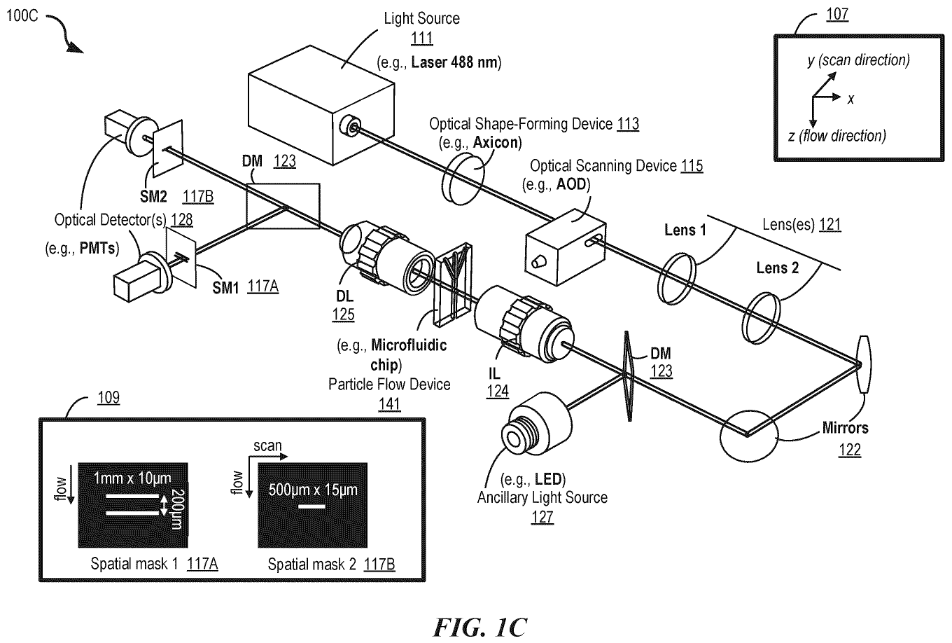

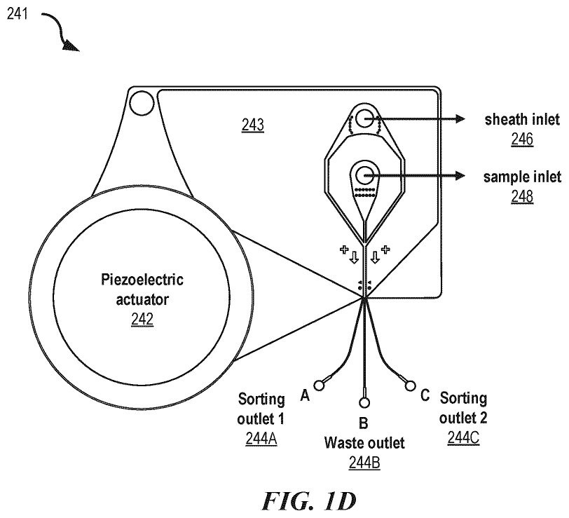

FIG. 1A shows a diagram illustrating an example embodiment of an image-guided, label free cell sorter system, labeled system 100, in accordance with the present technology. The system 100 includes an optical imaging system 110, a data processing and control unit 130 (also referred to as “data processing unit”) in communication with the optical imaging system 110, and a particle cell sorting unit 140 (also referred to as “sorting unit”) in communication with the data processing and control unit 130. In various embodiments, the system 100 is user-programmable to allow for multiple sorting protocols to sort individual particles from particle populations based on user-defined criteria that can be associated with one or more of a plurality of properties exhibited by each individual particle analyzed in real time by the data processing and control unit 130. Examples of particles include living cells, cell fragments, particle fragments, beads, or other types of particles, which can be among various nano-scale, micro-scale, and milli-scale sizes. Some example user-defined criteria include, but are not limited to, (i) an amount and/or size of sub-features of or on the individual particle (e.g., sub-particles attached to living cells, including particles engulfed by cells or attached to cells); (ii) an amount and/or size of the individual particle itself; (iii) the morphology of the individual particle; and/or (iv) a morphological feature of the individual particle. In this manner, the system 100 is able to evaluate and sort particles by properties, such as properties of living cells, including sorting by cellular physiological functionalities (e.g., particle or substance uptake by a cell, or particle engulfment by a cell), by cell damage, by localization of proteins, or by other cellular properties.

In some embodiments of the system 100, the particle or cell sorting unit 140 includes a particle motion device configured to move particles in a fluid along a travel path (e.g., in a motion or flow direction). For example, the sorting unit 140 can include a flow cell device that includes a substrate having a fluidic channel for carrying a fluid sample containing a flow specimen (e.g., particles, living cells, or other objects). In some embodiments, the sorting system 140 can include a fluid-flow focusing system to produce a confined sample fluid to a fine stream in the fluidic channel. In some embodiments, the fluidic channel of the flow cell device is configured in an interrogation area to be optically transparent, allowing for clear optical paths. The fluid containing the flow specimen flows along the flow direction through the interrogation area in the fluidic channel, where optical data are obtained by the optical imaging system 110 for each particle, including single particles or single cells.

In some embodiments, the sorting unit 140 includes an actuator device interfaced with the flow cell device, e.g., at a particle sorting area of the system 100. For example, the actuator device is configured to receive a sorting control command from the data processing and control unit 130 based on a programmable sorting criterium or criteria and execute the command to sort particular particles meeting the criterium or criteria into a separate flow channel (e.g., an output channel) of the flow cell device in accordance with the control command. The sorting control command can be established at the data processing and control unit 130 prior to and/or during (in real time of) an implementation of the system 100 to implement real-time, highly focused image-based sorting of particles, in which individual particles are imaged by the optical imaging system 110 in the interrogation area of the flow cell device and sorted by the actuator device in the sorting area of the flow cell device based on a determined property or properties analyzed by the data processing and control unit 130 in real time of the particle flow.

FIG. 1B shows a block diagram of an example embodiment of data processing and control unit 130 included in the image-guided, label free cell sorter system 100 of FIG. 1A. In various implementations, the data processing and control unit 130 is embodied on one or more personal computing devices, e.g., including a desktop computer, laptop computer, tablet, or mobile computing device including a smartphone or wearable computing device (e.g., smartwatch, smartglasses, etc.). In some implementations, the data processing and control unit 130 is embodied the one or more personal computing devices configured in a computer system or communication network accessible via the Internet (referred to as “the cloud”), which includes servers and/or databases in the cloud.

As illustrated in the diagram of FIG. 1B, the data processing and control unit 130 includes one or more processors 331 (referred to as “processor”) to process data, and one or more memory devices 332 (referred to as “memory”) in communication with the processor 331 to store and/or buffer data. For example, the processor 331 can include a central processing unit (CPU) or a microcontroller unit (MCU). In some implementations, the process 331 can include a field-programmable gate-array (FPGA) or a graphics processing unit (GPU). For example, the memory 332 can include and store processor-executable code, which when executed by the processor 331, configures the data processing and control unit 130 to perform various operations, e.g., receiving information, commands, and/or data, processing information and data, such as from the optical imaging system 110, and transmitting or providing processed information/data to another device, such as the sorting unit 140 (e.g., to an actuator device).

To support various functions of the data processing and control unit 130, the memory 332 can store information and data, such as instructions, software, values, images, and other data processed or referenced by the processor 331. For example, various types of Random Access Memory (RAM) devices, Read Only Memory (ROM) devices, Flash Memory devices, and other suitable storage media can be used to implement storage functions of the memory 132.

In some implementations, the data processing and control unit 130 includes an input/output unit 333 (referred to as “I/O” or “I/O unit”) to interface the processor 331 and/or memory 332 to other modules, units or devices. In some embodiments, such as for mobile computing device embodiments, the data processing and control unit 130 includes a wireless communications unit, e.g., such as a transmitter (Tx) or a transmitter/receiver (Tx/Rx) unit. For example, in such embodiments, the I/O unit 333 can interface the processor 331 and memory 332 with the wireless communications unit, e.g., to utilize various types of wireless interfaces compatible with typical data communication standards, which can be used in communications of the data processing and control unit 130 with other devices, e.g., such as between the one or more computers in the cloud and the user device. The data communication standards include, but are not limited to, Bluetooth, Bluetooth low energy (BLE), Zigbee, IEEE 802.11, Wireless Local Area Network (WLAN), Wireless Personal Area Network (WPAN), Wireless Wide Area Network (WWAN), WiMAX, IEEE 802.16 (Worldwide Interoperability for Microwave Access (WiMAX)), 3G/4G/LTE/5G cellular communication methods, and parallel interfaces.

In some implementations, the data processing and control unit 130 can interface with other devices using a wired connection via the I/O unit 333. The data processing and control unit 130 can also interface with other external interfaces, sources of data storage, and/or visual or audio display devices, etc. to retrieve and transfer data and information that can be processed by the processor 331, stored in the memory 332, or exhibited on an output unit of a display device or an external device. Although FIG. 1A shows a single data processing and control unit 130, the disclosed technology is not limited thereto. Thus, in some implementations, the image-guided, label free cell sorter system 100 can include multiple data processing and control units, each performing the respective operations, e.g., detecting the waveforms, reconstructing the cell images, and extracting cell image features and generating criteria. If the system 100 includes multiple data processing and control units, those multiple units can be located at one site or distributed across multiple sites and interconnected by a communication network.

FIG. 1C shows a diagram of an example embodiment of an optical imaging system in accordance with the present technology, labeled system 100C. In some embodiments, the system 100C includes a light source 111 (e.g., a laser) to produce an excitation beam, an optical shape-forming device 113 (e.g., axicon) to modify the shape of the excitation beam to have increased focal depth that is to be directed at an interrogation area of a particle flow device 141 (e.g., a microfluidic chip of the sorting unit 140), an optical scanning device 115 (e.g., an acousto-optic deflector (AOD)) to scan for light beam(s) from the interrogation area to acquire image data of individual particles flowing through the interrogation area of the particle flow device 141, one or more spatial filters (SM) 117 arranged in an optical path of the directed excitation beam, and optical components to direct the excitation beam at the interrogation area of the particle flow device 141. In some embodiments of the system 100C, for example, the optical components to direct and/or manipulate light, e.g., including the excitation beam and/or ancillary light in the optical path, can include one or more lenses 121; one or more mirrors 122; one or more dichroic mirrors (DM) 123; an illumination objective lens (IL) 124, e.g., 10×/0.28 lens; a detection objective lens (DL) 125, e.g., 10×/0.28 lens; and/or one or more optical detectors 128 (e.g., photomultiplier tubes (PMTs)). In the example embodiment shown in FIG. 1C, the one or more spatial filters 117 include a first spatial filter mask (SM1), labeled 117A, and a second spatial filter mask (SM2), labeled 117B). Example embodiments of the spatial filter masks SM1 117A and SM2 117B for cell speed detection and transmission imaging are shown in insert box 109, displayed on the bottom left of the diagram of FIG. 1C.

For the example optical system design of the system 100C shown in FIG. 1C, the Gaussian beam output from a 488 nm diode laser (example light source 111) illuminates on the optical shape-forming device 113 embodied by an axicon (AX1025-A, Thorlabs) with an angle of 0.5°. In implementations, for example, a Bessel-Gaussian beam is formed by the superposition of two sets of plane waves propagating with a cone angle. The Bessel-Gaussian beam is then modulated by the optical scanning device 115. In some embodiments, for example, the optical scanning device 115 may include an acousto-optic deflector (e.g., such as the AOD OAD948, Isomet); in some embodiments, for example, the optical scanning device 115 may include a scanning mirror system. In implementations of the example AOD, the acoustic transducer deflects the beam to different angles along the y- (scanning) direction (shown in coordinate legend 107 of FIG. 1C), e.g., at a frequency of 200 KHz. The optical system design of the system 100C shown in FIG. 1C includes multiple optical lenses 121, e.g., Lens1 to perform a Fourier transform of the zero order Bessel-Gaussian beam to create an annulus-shaped beam at its focal plane; and Lens2 to then magnify this annulus-shaped beam before reaching the exit pupil of the IL 124 (embodied by a 10× illumination objective lens (378-803-3, Mitutoyo). The optical system design of the system 100C shown in FIG. 1C includes mirrors 122 to modify the direction of the optical path, e.g., which can be used to reduce a spatial footprint of the system 100C. The illumination objective lens 124 transforms the annulus-shaped beam back to a Bessel-Gaussian beam onto particles in flow (e.g., cells) in the microfluidic channel of the particle flow device 141 (embodied by a microfluidic chip). The position of the AOD (optical scanning device 115) is conjugate with the back focal plane of the detection objective lens 125. This configuration can create a fan scan of the laser beam at the front focal plane. The microfluidic chip, e.g., which can be made of cyclic olefin copolymer (COC) as shown in FIG. 1D, is put at the front focal plane.

The example optical system design of the system 100C shown in FIG. 1C uses a single PMT detector and an AOD-scanned CW laser to encode the 2D cell transmission profile into a temporal signal, which can be used as the gating criteria for cell sorting and classification. The optical system design of the system 100C includes a spatial mask 117B (SM2 in FIG. 1C) with one 500 μm×15 μm slit that is placed at the image plane of the 488 nm laser channel, which creates a 50 μm×1.5 μm transparent area at the focal plane. The slit is aligned to the center of the Bessel-Gaussian beam. As a result, the spatial mask 117B is operable to block the sidelobes of the Bessel-Gaussian beam along the flow direction while the sidelobes along the scanning direction can pass the slit.

Since cell speed in the microfluidic channel is position dependent and the speed information is required to correctly relate the temporal waveform to the cell image, an ancillary optical system can be used to monitor the flow speed of each individual particle in real-time during a high-focused image-encoding cell sorting process. For example, in some embodiments like the example optical system design of the system 100C shown in FIG. 1C, (optional) ancillary light source 127 embodied by a 455 nm LED is configured to direct a second light (e.g., LED light) at a first (optional) dichroic mirrors (DM) 123 to illuminate on the particle flow device 141 and be measured using an (optional) optical detector 128 (embodied by a PMT) positioned proximate a (optional) spatial mask 117A (SM1 in FIG. 1C) to detect the speed of each individual particle (e.g., cell). The example spatial mask 117A contains two 1 mm×10 μm slits separated in the cell flow (z-) direction, placed at the image plane of 455 nm LED channel. The speed of each cell is obtained by dividing the slit distance with the magnification factor (e.g., 10× for some implementations) and the time difference between the minima in the LED transmission signal. In some implementations, cell speeds were typically measured between 10 cm/s and 25 cm/s, with an average speed of around 20 cm/s.

FIG. 1D shows a diagram of an example embodiment of a microfluidic sorting chip 241 for a particle flow device of the sorter unit 140, such as the example microfluidic chip embodiment of the particle flow device 141 shown in FIG. 1C. In the example microfluidic chip shown in FIG. 1D, labeled microfluidic chip 241, the example chip can be made of cyclic olefin copolymer (COC) by injection molding. The microfluidic sorting chip 241 includes a substrate 243 having one or more channels for fluid flow, where a sheath inlet 246 and a sample inlet 248 interface with the one or more channels for fluid flow. The microfluidic sorting chip 241 includes a piezoelectric actuator 242 to actuate an actionable response to a sorting criteria instruction to direct individual particles in the fluid through one of a sorting outlet (or one outlet among a plurality of sorting outlets, e.g., first sorting outlet 244A and second sorting outlet 244C) or waste outlet 244B. The output from the sorting outlet(s) and/or waste outlet can be in fluid communication with corresponding collection units.

In some implementations, for example, the one or more channels of the microfluidic sorting chip 241 includes a sample channel configured to carry particles (e.g., cells) suspended in a fluid that flows in a flow direction, and one or more sheath channels configured to provide sheath flow of fluid to hydrodynamically focus the suspended particles in the fluid prior to flowing through an illumination area of the microfluidic sorting chip 241. In some embodiments, for example, the substrate of the microfluidic sorting chip 241 can be formed in a bulk material, e.g., such as polydimethylsiloxane (PDMS), which can be (optionally) bonded to a base substrate, e.g., a glass base substrate or base substrate of other material. In some implementations, for example, the microfluidic sorting chip 241 is optically interfaced with the optical scanning device 115 (e.g., AOD) can provide for controllable, high-speed changing of the angle of the light beam with high optical efficiency, where the AOD 115 moves the energy of the beam without losing portions of the beam with respect to imaging planes on/in the microfluidic chip 241. The example AOD 115 is able to redirect light reliably with high speed and efficiency.

In some embodiments of the microfluidic sorting chip 241, COC is chosen due to its high transparency in the visible wavelength, low autofluorescence, and low fabrication cost. The piezoelectric actuator 242 is attached to the top of the example COC microchip (e.g., on substrate of microfluidic sorting chip 241), e.g., via a thin layer of double-sided PSA (pressure sensitive adhesive). The sample stream is focused by the sheath flow hydrodynamically. When a target cell is detected, the piezo-actuator 242 is triggered to push or pull the target cell to a first sorting outlet 244A or a second sorting outlet 244C and eventually into a collection unit, e.g., collection tubes or specific wells of a well plate, e.g., such as a 384-well plate. Cells that are not of interest travel through the center channel to the waste outlet 244B.

### B. Example Simulation of the Bessel-Gaussian Beam Transmission Signal

In example implementations of some embodiments of the system 100C, e.g., to gain insight into the transmission of a Bessel-Gaussian beam through an object, COMSOL Multiphysics simulation software was used to show how a 7 μm bead (n=1.6) changes the optical intensity distribution of a Bessel-Gaussian beam.

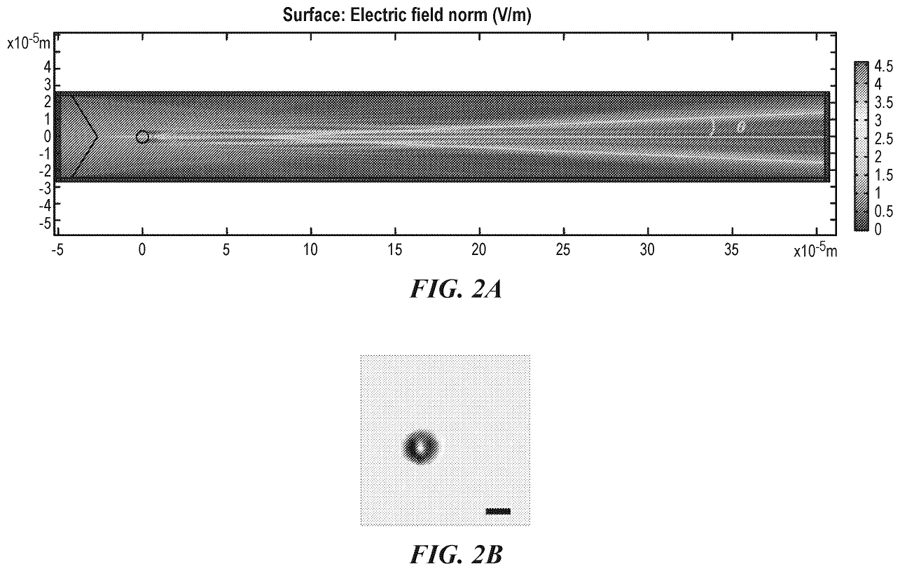

FIGS. 2A and 2B show an example COMSOL simulation of the electric field when a Bessel-Gaussian beam illuminates on the center of a 7 μm bead (FIG. 2A) and an example transmission image of a 7 μm bead generated by the image-guided cell sorter using a scanning Bessel-Gaussian beam (FIG. 2B). The image was reconstructed using the mathematical algorithm discussed in Section D; and the example scale bar is 5 μm.

Since the example system measures the far field of the transmitted light, the electric field distribution was simulated 400 μm away from the bead to satisfy the Fraunhofer far-field condition. When there is no object in the interrogation zone, the laser light transmits through the slit and generates a constant DC background. When the laser beam intersects the bead, the light will be partially reflected and partially diffracted. If the diffraction angle θ is greater than the collection angle of the detection objective lens, the light intensity on the PMT decreases, resulting in a dark region in the transmission image of the 7 μm bead due to the combined effects of reflection and diffraction assuming the effect of light absorption is negligible. According to the example simulation, when the Bessel-Gaussian beam hits the center of the 7 μm bead, the calculated diffraction angle θ is around 2 degrees, much smaller than the collection angle of the detection objective (10×, NA=0.28). Thus, the small angle diffraction beam can pass the slit and reach the PMT, producing a “bright spot” at the center of the image of the bead. This can explain the observation of a bright spot at the center of the restored bead image from the transmitted signal (FIG. 2B). As a general rule, areas of large optical density and large angle scattering give rise to dark regions; and areas of low optical density and small angle scattering give rise to bright regions in the restored transmission images.

### C. Depth of Focus Comparison

As discussed previously, a main motive of using a Bessel-Gaussian beam (e.g., instead of a Gaussian beam) in image-encoded cell sorting is to extend the focal depth such that objects in different positions in a microfluidic channel and different cross sections of the cell can all be focused to generate high fidelity 2D cell image information.

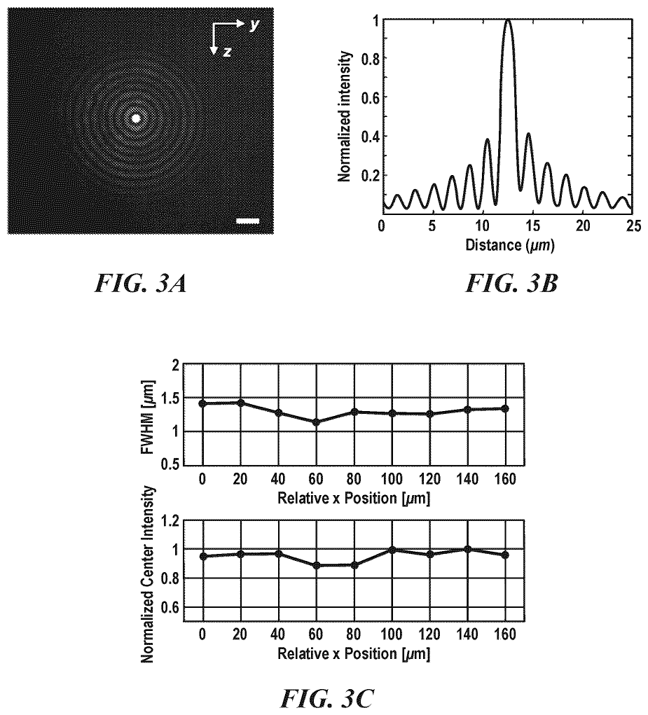

FIGS. 3A-3C show plots depicting the intensity profile and focal depth of the Bessel-Gaussian beam measured by a camera. FIGS. 3A and 3B show the intensity profile of the Bessel-Gaussian beam at the image plane. The full width half maximum (FWHM) of the center lobe is between 1 μm and 1.5 μm. For instance, a significant amount of energy is in the side lobes, which excite areas outside the central spot and complicate the waveform analysis when we use a single PMT for detection to keep the system simple and at low cost. A mathematical algorithm (discussed in the next section of this disclosure) can be implemented to deconvolve the signal when the transmission image is reconstructed. To measure the focal depth, beam profiles at different depths are recorded by moving the detection objective lens along the beam propagation (x-) direction. Both the maximum intensity and FWHM of the center lobe have relatively small changes within a distance of 160 μm, as shown in FIG. 3C. In contrast, a Gaussian beam produced by the same objective lens has a much shorter focal depth of about 7.37 μm.

FIG. 3A shows a camera image measured beam profile at the image plane. FIG. 3B shows an image depicting a normalized intensity from the center of the Bessel-Gaussian beam. FIG. 3C shows an image depicting a full-width-half-maximum and normalized light intensity of the main lobe of Bessel-Gaussian beam.

To assess how the extended focal depth of a Bessel-Gaussian beam can improve the detection yield compared to a Gaussian beam, example implementations included running a mixture of cells and beads in a comparative image-based object sorting study, e.g., including 15 μm beads, 7 μm beads, HEK 293T cells, MCF7 cells and Hela cells, using both Gaussian beam and Bessel-Gaussian beam image-guided cell sorters. The example results of this example study are summarized in Table 1.

In the Gaussian beam system, the short focal depth cannot keep the majority of objects in focus due to the wide distribution of the objects along the microfluidic channel. Except for 15 μm beads that tend to take a stable position in the channel, only 30-40%7 μm beads, and only 40-60% cells are in focus. In sharp contrast, >90% of 7 μm beads, 98% of 15 μm beads, and 85% of the cells of all kinds are in focus in the Bessel-Gaussian beam system.

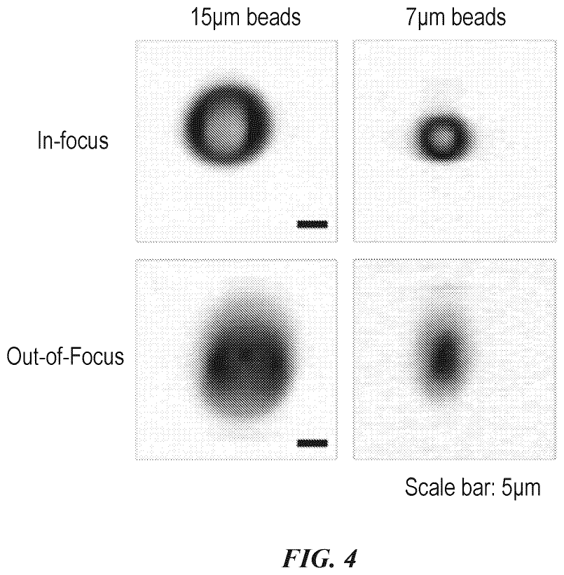

FIG. 4 shows example in-focus and out-of-focus 15 μm bead and 7 μm bead images generated by the Gaussian beam system. In sharp contrast, the vast majority of both 15 μm and 7 μm diameter beads are well focused for the Bessel-Gaussian beam system.

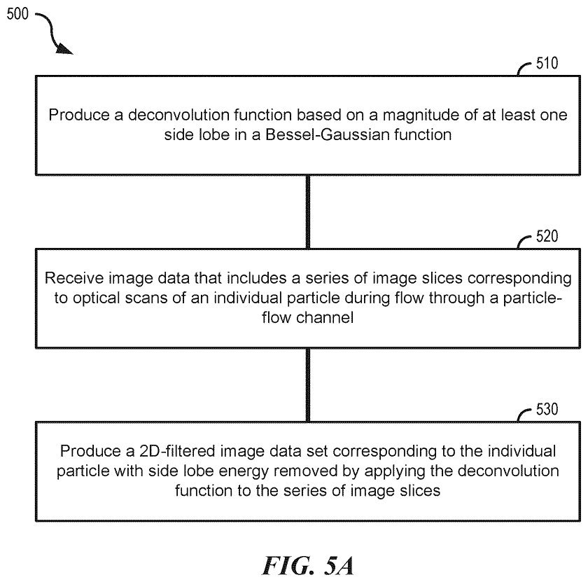

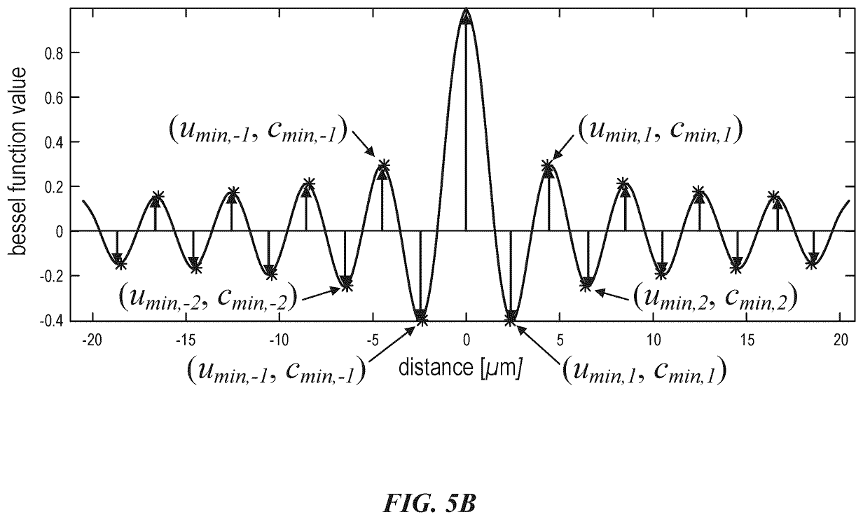

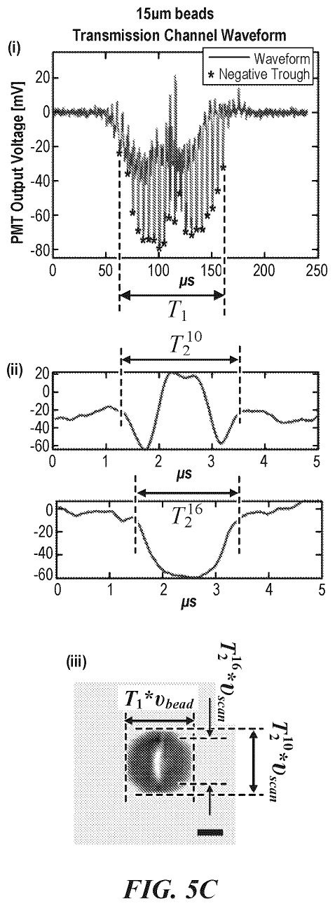

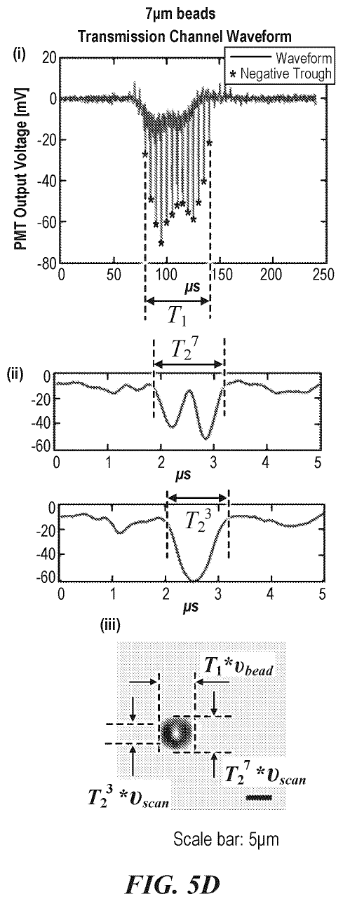

The image of FIG. 4 shows examples of in-focus (first row) and out-of-focus (second row) images for 15 μm and 7 μm beads, generated by a scanning Gaussian beam image-guided cell sorter. In comparison, nearly all images from the scanning Bessel-Gaussian beam system are well in focus (see FIG. 5); scale bar is 5 μm.

Table 1 shows a comparison of the ratio of in-focus objects between the scanning Gaussian beam system and the scanning Bessel-Gaussian beam system.

TABLE 1

| | | Bessel- |
|---|---|---|
| | Gaussian | Gaussian |
| | System | System |
| 7 μm Beads | 30%-40% | 90%-95% |
| 15 μm Beads | ~98% | ~98% |
| Cell Mixture | 40%-60% | 85%-90% |

### D. Image Reconstruction Algorithm

In this section, an algorithm for reconstructing images from the label-free, transmission signal by a Bessel-Gaussian beam is described. It is noted that because of the correlation between the PMT temporal signal and the image features, the system does not need to use the restored cell images as gates to sort cells. Instead, cells can be sorted directly from the features in the waveform, thus saving time and resources for real time signal processing. Therefore, image reconstruction can be performed off-line for validation of the results and improved human-machine interface when users would like to observe image differences between sorted and unsorted cells and visualize image related features such as size, shape, granularity, contrast, etc.

FIG. 5A shows a flow diagram of an example embodiment of an image reconstruction method, labeled 500, for eliminating side lobe energy in a scanned Bessel-Gaussian beam, e.g., implementable in real-time with a method for label-free, image-based particle sorting in accordance with the present technology. In some implementations of the method 500, the method 500 can be used to algorithmically eliminate side lobe energy in a second dimension from two-dimensional (2D) image data of individual particles flowing through a flow channel (e.g., corresponding to photocurrent data obtained by a PMT), where side lobe energy in a first dimension of the 2D image data was physically eliminated (i.e., filtered) by a spatial mask (e.g., spatial mask 117B of the system 100C), so as to collectively eliminate side lobe energy in both dimensions of the 2D image data.

The method 500 includes a process 510 to produce a deconvolution function, e.g., approximating the deconvolution function, based on a magnitude of at least one side lobe in a Bessel-Gaussian function. In some implementations, for example, the process 510 includes creating the Bessel-Gaussian function as a series of delta functions at maxima and minima, where the approximated deconvolution function can be represented in a fixed value matrix form, [T].

The method 500 includes a process 520 to receive image data, e.g., at a data processing system in communication with an optical detector device (such as a PMT) in some example implementations. For example, in implementations of the process 510, the received image data can include or be organized into 2D image data that comprises a plurality of AOD scan slices, e.g., stitched together to form the 2D image slices. For instance, an AOD-based scanned image includes one planar image slice of the particle among a plurality of planes across at least some or all of the particle. In various examples, the AOD scan slices can be packaged as an image data set. As previously discussed, for the image data set of a particle imaged during flow, the side lobe energy of the imaged particle may already have been physically eliminated via spatial filtering during imaging. In implementations of the method 500, for example, the process 510 and the process 520 can be performed in any sequential order or concurrently, or at least partially concurrently.

The method 500 includes a process 530 to perform a deconvolution of the received image data scan slices, e.g., using the deconvolution function of the process 510, to produce a data set (e.g., a 2D-filtered image data set) corresponding to the individual particle with side lobe energy removed in two dimensions. In some implementations of the process 530, for example, deconvoluted image data set includes multiplying digital data indicative of each 2D image slice in the image data set by the fixed value matrix [T] based on the deconvolution function.

The method 500 can be implemented during particle sorting applications using any of the embodiments of the system 100 disclosed herein, as well as other image-based particle sorting systems.

### Example Information on the Image Reconstruction Method

Below is a description of an example embodiment of the algorithm (and the method 500) using devised mathematical formulas and techniques, in accordance with the present technology.

The electric field of a Bessel-Gaussian beam can be written as

$${E}_{B G} ( r , x ) = {E}_{0} {J}_{0} ( {k}_{r} r ) \frac{{w}_{0}}{w ( x )} {e}^{- \frac{{r}^{2}}{{w}_{0}^{2}}} \cdot {e}^{- i {k}_{x} x} {e}^{- i ∅} \qquad ( 1 )$$

where r=\sqrt{y²+z²} is the distance from the center of the Bessel-Gaussian beam; E₀ is a field amplitude constant; kᵣ is the wavevector in the transverse plane and kᵣ²+kₓ²=k²; w₀ is the waist width of Gaussian amplitude.

$$∅ = {tan}^{- 1} \frac{x}{{x}_{0}} ;$$

and x₀ is Kayleigh length of the Gaussian beam.

The algorithm can use n(x,y,z) to denote the cell or bead index profile n(x,y,z)=nₒ+Δn(x,y,z). We assume nₒ is the index of water and Δn>0 since the index of cells and beads is greater than the index of water. Assume cell or bead thickness is within x_{c}. For the 2D imaging system, we cannot resolve index change along the beam propagation direction, so we make the following approximation:

∫₀^{x}^{_{c}}Δn(x,y,z)dx=Δñ(y,z)x_{c} (2)

Adding a slit in parallel with the laser scanning (y-) direction on the image plane and assuming the slit is narrow enough to be approximated by a 1-D delta function in its transmission characteristic, the transmitted field focused by a lens and after the slit can be approximated by Equation (3).

$${E}_{t} ( {y}^{′} , {z}^{′} ) = {E}_{0}^{′} {e}^{- i {k}_{o} x} {e}^{- i ∅} \frac{{w}_{0}}{w ( x )} {\int }_{y} {\int }_{z} δ ( z - {z}^{′} ) ( \frac{2 \sqrt{{n}_{o} ( {n}_{o} + Δ \overline{n} ( y , z )}}{2 {n}_{o} + Δ \overline{n} ( y , z )} ) {J}_{0} [ {k}_{r} \sqrt{{( {y}^{′} - y )}^{2} + {( {z}^{′} - z )}^{2}} ] {e}^{- \frac{{( {y}^{′} - y )}^{2} + {( {z}^{′} - z )}^{2}}{{w}_{0}^{2}}} {e}^{- i {k}_{o} Δ \overline{n} ( y , z ) {x}_{c}} d ydz \qquad ( 3 )$$

The term

$$( \frac{2 \sqrt{{n}_{o} ( {n}_{o} + Δ \overline{n} ( y , z )}}{2 {n}_{o} + Δ \overline{n} ( y , z )} )$$

in Equation (3) is the approximate transmission coefficient assuming there is no absorption. Here (y,z) refers to the transverse coordinate in the object plane, and (y′,z′) refers to the transverse coordinate in the image (detection) plane. For simplicity, we have transformed the actual position (Y′,Z′) in the image plane into (y′,z′) by defining

$${y}^{′} = \frac{{Y}^{′}}{M} and {z}^{′} = \frac{{Z}^{′}}{M}$$

with M being the magnification of the detection optics.

Also note that (y′,z′) is related to the time by the following relations:

$${y}^{′} = \frac{F O {V}_{y}}{T} t \qquad ( 4 ‐ a )$$

$${z}^{′} = {v}_{flow} t \qquad ( 4 ‐ b )$$

where FOV_{y} is the field-of-view in the y- (scanning) direction, T is the time for each AOD scan (5 μs in our system), and v_{flow} is the flow speed of the object (e.g., around 20 cm/s in example systems described herein). For a 40 μm field-of-view in the scanning direction and an AOD scanning period of 5 μs, the scanning speed is 8 m/s, which is 40 times faster than the average cell travel speed. This allows us to treat the scanning along the y-axis as if the cell is nearly still in the z-axis.

From the relations in Equation (4), we can relate a signal in time domain to the space domain, thus reconstructing the image from a temporal waveform.

To analyze the detected cell transmission signal behind the slit when the center of the scanning Bessel-Gaussian beam is at a given position in the flow (z′-) direction, we can represent the transmitted field in Equation (5) under a given position z′.

$${{E}_{t} ( {y}^{′} ) \vert}_{z ′} ∝ \qquad ( 5 )$$

$${\int }_{y} ( \frac{2 \sqrt{{{n}_{o} ( {n}_{o} + Δ \overline{n} ( y ) \vert}_{z ′}}}{{2 {n}_{o} + Δ \overline{n} ( y ) \vert}_{z ′}} ) {J}_{0} [ {k}_{r} \sqrt{{( {y}^{′} - y )}^{2}} ] {e}^{- \frac{{( {y}^{′} - y )}^{2}}{{w}_{0}^{2}}} {e}^{{- {ik}_{o} Δ \overline{n} ( y ) \vert}_{z ′} {x}_{c}} dy$$

Equation (5) shows that Eₜ(y′)|_{z}, is the convolution of the index function

$$( \frac{2 \sqrt{{{n}_{o} ( {n}_{o} + Δ \overline{n} ( y ) \vert}_{z ′}}}{{2 {n}_{o} + Δ \overline{n} ( y ) \vert}_{z ′}} ) {e}^{{- {ik}_{o} Δ \overline{n} ( y ) \vert}_{z ′} {x}_{c}}$$

and the Bessel Gaussian function

$${J}_{0} [ {k}_{r} y ] {e}^{- \frac{{y}^{2}}{{w}_{0}^{2}}}$$

along the scanning (y-) direction. To save computational power for image reconstruction, for example, we approximate the Bessel function J₀[kᵣy] by a series of delta functions at its maxima and minima:

$${J}_{o} ( u ) \sim {\sum }_{m} {c}_{max , m} δ ( u - {u}_{max , m} ) + {\sum }_{n} {c}_{min , n} δ ( u - {u}_{min , n} ) \\ {u}_{max , m} : positions of mth maximum of {J}_{0} ( u ) . {J}_{o} ( {u}_{max , m} ) > 0 ; \\ m = 0 , \pm 1 , \pm 2 , \pm 3 , … \\ {u}_{min , n} : positions of nth minimum of {J}_{o} ( u ) . {J}_{o} ( {u}_{min , n} ) < 0 ; \\ n = \pm 1 , \pm 2 , \pm 3 , … \qquad ( 6 )$$

The coefficients for each delta function are defined as:

$$\begin{matrix}{c}_{max , m} = {J}_{0} ( {u}_{max , m} ) & m = 0 , \pm 1 , \pm 2 , \pm 3 , … \\ {c}_{min , n} = {J}_{0} ( {u}_{min , n} ) & n = \pm 1 , \pm 2 , \pm 3 , …\end{matrix}$$

Substituting Equation (6) into Equation (5) and dropping the parameter z′ for simplicity, we obtain the following approximate expression of the transmitted E-field behind the slit,

$${{E}_{t} ( {y}^{′} ) \vert}_{z ′} \sim [ {\sum }_{m} {C}_{max , m} exp [ - \frac{{u}_{max , m}^{2}}{{( {k}_{r} {w}_{o} )}^{2}} ] ( \frac{2 \sqrt{{{n}_{o} ( {n}_{o} + Δ \overline{n} ( {y}^{′} - \frac{{u}_{max , m}}{{k}_{r}} ) \vert}_{z ′}}}{{2 {n}_{o} + Δ \overline{n} ( {y}^{′} - \frac{{u}_{max , m}}{{k}_{r}} ) \vert}_{z ′}} ) {e}^{{- {ik}_{o} Δ \overline{n} ( {y}^{′} - \frac{{u}_{max , m}}{{k}_{r}} ) \vert}_{z ′} {x}_{c}} ] - [ {\sum }_{n} {C}_{min , n} exp [ - \frac{{u}_{min , n}^{2}}{{( {k}_{r} {w}_{o} )}^{2}} ] ( \frac{2 \sqrt{{{n}_{o} ( {n}_{o} + Δ \overline{n} ( {y}^{′} - \frac{{u}_{min , n}}{{k}_{r}} ) \vert}_{z ′}}}{{2 {n}_{o} + Δ \overline{n} ( {y}^{′} - \frac{{u}_{min , n}}{{k}_{r}} ) \vert}_{z ′}} ) {e}^{{- {ik}_{o} Δ \overline{n} ( {y}^{′} - \frac{{u}_{min , n}}{{k}_{r}} ) \vert}_{z ′} {x}_{c}} ] \qquad ( 7 )$$

Representing Eₜ(y′)˜A−B in brief form, we can write the transmitted power through the slit as

$${{{{J}_{t} ( {y}^{′} ) \vert}_{z ′} ∝ {E}_{t}^{*} ( {y}^{′} ) \vert}_{z ′} {E}_{t} ( {y}^{′} ) \vert}_{z ′} ∝ {AA}^{*} + {BB}^{*} - {AB}^{*} - {BA}^{*} \qquad ( 8 )$$

It can be shown that Equation (8) can be approximated as:

$${J}_{t} ( {y}^{′} , x ) \sim \frac{{4 {n}_{o} ( {n}_{o} + Δ \overline{n} ( {y}^{′} ) \vert}_{z ′}}{{{( 2 {n}_{o} + Δ \overline{n} ( {y}^{′} ) \vert}_{z ′} )}^{2}} + \qquad ( 9 )$$

$$[ {\sum }_{m \neq 0} {C}_{max , m}^{2} exp [ - \frac{2 {u}_{max , m}^{2}}{{( {k}_{r} {w}_{o} )}^{2}} ] \frac{{4 {n}_{o} ( {n}_{o} + Δ \overline{n} ( {y}^{′} - \frac{{u}_{max , m}}{{k}_{r}} ) \vert}_{z ′}}{{{( 2 {n}_{o} + Δ \overline{n} ( {y}^{′} - \frac{{u}_{max , m}}{{k}_{r}} ) \vert}_{z ′} )}^{2}} ] +$$

$$[ {\sum }_{n} {C}_{min , n}^{2} exp [ - \frac{2 {u}_{min , n}^{2}}{{( {k}_{r} {w}_{o} )}^{2}} ] \frac{{4 {n}_{o} ( {n}_{o} + Δ \overline{n} ( {y}^{′} - \frac{{u}_{min , n}}{{k}_{r}} ) \vert}_{z ′}}{{{( 2 {n}_{o} + Δ \overline{n} ( {y}^{′} - \frac{{u}_{min , n}}{{k}_{r}} ) \vert}_{z ′} )}^{2}} ]$$

To obtain Equation (9), for example, we have ignored summations of terms with a random phase φₘₙ such as

$${{{\sum }_{m , n} {e}^{- i {φ}_{mn}} where {φ}_{m , n} = {k}_{o} {x}_{c} [ Δ \overline{n} ( {y}^{′} - \frac{{u}_{max , m}}{{k}_{r}} ) \vert}_{z ′} - Δ \overline{n} ( {y}^{′} - \frac{{u}_{min , n}}{{k}_{r}} ) \vert}_{z ′} ] .$$

In other words, we have only kept the phase-matched terms with φₘₙ=0.

According to Equation (9), when the beam center hits a high index spot,

$${\frac{4 {n}_{o} ( {n}_{o} + Δ \overline{n} ( {y}^{′} )}{{( 2 {n}_{o} + Δ \overline{n} ( {y}^{′} ) )}^{2}} \vert}_{z ′} < 1 ,$$

the light intensity through the slit would yield a lower than 100% transmission. When the beam center hits a low index position (e.g., water only), the first term in (9) is maximum, but the values in the second and third term depend on the index values

$${{Δ \overline{n} ( {y}^{′} - \frac{{u}_{max , m}}{{k}_{r}} ) \vert}_{z ′} and Δ \overline{n} ( {y}^{′} - \frac{{u}_{min , n}}{{k}_{r}} ) \vert}_{z ′}$$

relative to the maxima and minima of the side lobes. In order to reconstruct the image from the measured PMT signal, we need to solve Δn̅(y)|_{z} or simply Δn̅(y,z). Next, we describe the algorithm to obtain Δn̅(y,z) from Equation (9).

Define

$${f ( y , z ) = \frac{4 {n}_{o} ( {n}_{o} + Δ \overline{n} ( y )}{{( 2 {n}_{o} + Δ \overline{n} ( y ) )}^{2}} \vert}_{z} .$$

By solving f(y,z), we can know the index profile of the object Δn̅(y,z).

Equation (9) can be represented in matrix form as:

$${J}_{t} [ {y}_{1}^{′} , {y}_{2}^{′} , … , {y}_{N}^{′} ; {z}_{j}^{′} ] = [ T ] * f [ {y}_{1}^{′} , {y}_{2}^{′} , … , {y}_{N}^{′} ; {z}_{j}^{′} ] \qquad ( 10 )$$

where j denotes the z-position of the cell in the flow direction after j times of AOD scans. The T-matrix is a 251×251 matrix. The dimension of the matrix is determined as follows: At a sampling rate of 25 MS/s and for a single scan of 5 μs, we produce 125 data points corresponding to the center positions of the Bessel-Gaussian beam over the 40 μm scanning range. However, the Bessel-Gaussian beam has side lobes.

Assuming that the side lobes on each side of the beam center span 20 μm, we have the scanning Bessel-Gaussian beam cover a total range of 80 μm, thus producing a total of 251 points in the transfer matrix in Equation (10). The elements of the T-matrix are defined as follow:

$${T}_{ij} = 1. if i = j , - 65 \leq i , j \leq 185 \\ {T}_{ij} = {C}_{l}^{2} exp [ - \frac{2 {u}_{l}^{2}}{{( {k}_{r} {w}_{o} )}^{2}} ] ≡ {a}_{l}^{2} where \\ {u}_{l} is the lth min or max for {J}_{0} ( u ) if {y}_{i}^{′} - \frac{{u}_{l}}{{k}_{r}} = {y}_{j}^{′} \\ {T}_{ij} = 0. Otherwise \qquad Equation ( 11 )$$

Then Δn̅(y,z) can be obtained from Equation (12),

$$f [ {y}_{1}^{′} , {y}_{2}^{′} , … , {y}_{N}^{′} ; {z}_{j}^{′} ] = {[ T ]}^{- 1} * {J}_{t} [ {y}_{1}^{′} , {y}_{2}^{′} , … , {y}_{N}^{′} ; {z}_{j}^{′} ] \qquad ( 12 )$$

From Equation (12), we can reconstruct the transmission image of the object from the PMT signal.

### Example Implementations of the Image Reconstruction Algorithm

Additional information about the algorithm is described for example implementations of the algorithm for image reconstruction and protocols for sample preparation.

### I. Image Reconstruction Algorithm

The electric field of Bessel-Gaussian beam:

$${E}_{B G} ( r , x ) ∼ {E}_{0} {J}_{0} ( {k}_{r} r ) \frac{{w}_{0}}{w ( x )} {e}^{- \frac{{r}^{2}}{{w}_{0}^{2}}} \cdot {e}^{- i {k}_{x} x} {e}^{- i ∅} \qquad ( S1 )$$

where r=\sqrt{y²+z²} is the distance from the center of the Bessel-Gaussian beam. E₀ is a field amplitude constant. kᵣ is the wavevector in the transverse plane and kᵣ²+kₓ²=k². w₀ is the waist width of Gaussian amplitude.

$$∅ = {tan}^{- 1} \frac{x}{{x}_{0}} .$$

x₀ is Rayleigh length of the Gaussian beam.

We use n(x,y,z) to denote the cell or bead index profile n(x,y,z)=nₒ+Δn(x,y,z). We assume nₒ is the index of water and Δn>0 since the index of cells and beads is greater than the index of water. Assume cell or bead thickness is within x_{c}. For the 2D imaging system, we cannot resolve index change along the beam propagation direction, so we make the following approximation:

∫₀^{x}^{_{c}}Δn(x,y,z)dx=Δn̅(y,z)x_{c} (S2)

Adding a slit in parallel with the laser scanning (y-) direction on the image plane and assuming the slit is narrow enough to be approximated by a 1-D delta function in its transmission characteristic, the transmitted field focused by a lens and after the slit can be approximated by (S3).

$${E}_{t} ( {y}^{′} , {z}^{′} ) = {E}_{0}^{′} {e}^{- i {k}_{o} x} {e}^{- i ∅} \frac{{w}_{0}}{w ( x )} {\int }_{y} {\int }_{z} δ ( z - {z}^{′} ) ( \frac{2 \sqrt{{n}_{o} ( {n}_{o} + Δ \overline{n} ( y , z )}}{2 {n}_{o} + Δ \overline{n} ( y , z )} ) {J}_{0} [ {k}_{r} \sqrt{{( {y}^{′} - y )}^{2} + {( {z}^{′} - z )}^{2}} ] {e}^{- \frac{{( {y}^{′} - y )}^{2} + {( {z}^{′} - z )}^{2}}{{w}_{0}^{2}}} {e}^{- i {k}_{o} Δ \overline{n} ( y , z ) {x}_{c}} dydz \qquad ( S3 )$$

The term

$$( \frac{2 \sqrt{{n}_{o} ( {n}_{o} + Δ \overline{n} ( y , z )}}{2 {n}_{o} + Δ \overline{n} ( y , z )} )$$

in Eq. (S3) is the approximate transmission coefficient assuming there is no absorption. Here (y,z) refers to the transverse coordinate in the object plane, and (y′,z′) refers to the transverse coordinate in the image (detection) plane. For simplicity, we have transformed the actual position (Y′,Z′) in the image plane into (y′,z′) by defining

$${y}^{′} = \frac{{Y}^{′}}{M} and z = \frac{{Z}^{′}}{M}$$

with M being the magnification of the detection optics.

Also note that (y′,z′) is related to time by the following relations:

$${y}^{′} = \frac{{FOV}_{y}}{T} t \qquad ( S4 - a )$$

$${z}^{′} = {v}_{cell} t \qquad ( S4 - b )$$

From the relations in (S4), we can relate a signal in time domain to the space domain, thus reconstructing the image from a temporal waveform.

To analyze the detected cell transmission signal behind the slit when the center of the scanning Bessel-Gaussian beam is at a given position in the flow (z′-) direction, we can represent the transmitted field in (S5) under a given position z′.

$${{E}_{t} ( {y}^{′} ) \vert}_{{z}^{′}} ∝ {\int }_{y} ( \frac{2 \sqrt{{{n}_{o} ( {n}_{o} + Δ \overline{n} ( y ) \vert}_{{z}^{′}}}}{{2 {n}_{o} + Δ \overline{n} ( y ) \vert}_{{z}^{′}}} ) {J}_{0} [ {k}_{r} \sqrt{{( {y}^{′} - y )}^{2}} ] {e}^{- \frac{{( {y}^{′} - y )}^{2}}{{w}_{0}^{2}}} {e}^{{- i {k}_{o} Δ \overline{n} ( y ) \vert}_{{z}^{′}} {x}_{c}} d y \qquad ( S5 )$$

Equation (S5) shows that Eₜ(y′)|_{z}, is the convolution of the index function

$$( \frac{2 \sqrt{{{n}_{o} ( {n}_{o} + Δ \overline{n} ( y ) \vert}_{{z}^{′}}}}{{2 {n}_{o} + Δ \overline{n} ( y ) \vert}_{{z}^{′}}} ) {e}^{{- i {k}_{o} Δ \overline{n} ( y ) \vert}_{{z}^{′}} {x}_{c}}$$

and the Bessel Gaussian function

$${J}_{0} [ {k}_{r} y ] {e}^{- \frac{{y}^{2}}{{w}_{0}^{2}}}$$

along the scanning (y-) direction. To save computational power for image reconstruction, we approximate the Bessel function J₀[kᵣy] by a series of delta functions at its maxima and minima, illustrated in FIG. 5B:

$${J}_{0} ( u ) ∼ {\sum }_{m} {c}_{max , m} δ ( u - {u}_{max , m} ) + {\sum }_{n} {c}_{min , n} δ ( u - {u}_{min , n} ) \qquad ( S6 )$$

$$where :$$

$${u}_{max , m} : positions of mth maximum of {J}_{o} ( u ) .$$

$${J}_{0} ( {u}_{max , m} ) > 0 ; m = 0 , \pm 1 , \pm 2 , \pm 3 , …$$

$$and where :$$

$${u}_{min , n} : positions of nth minimum of {J}_{0} ( u ) .$$

$${J}_{0} ( {u}_{min , n} ) < 0 ; n = \pm 1 , \pm 2 , \pm 3 , …$$

The coefficients for each delta function are defined as

$${c}_{max , m} = {J}_{0} ( {u}_{max , m} ) m = 0 , \pm 1 , \pm 2 , \pm 3 , … \\ {c}_{min , n} = {J}_{0} ( {u}_{min , n} ) n = \pm 1 , \pm 2 , \pm 3 , … \qquad ( S7 )$$

Substituting (S6) and (S7) into (S5) and dropping the parameter z′ for simplicity, we obtain the following approximate expression of the transmitted E-field behind the slit,

$${{E}_{t} ( y ) \vert}_{{z}^{′}} ∼ [ {\sum }_{m} {C}_{max , m} exp [ - \frac{{u}_{max , m}^{2}}{{( {k}_{r} {w}_{o} )}^{2}} ] ( \frac{2 \sqrt{{{n}_{o} ( {n}_{o} + Δ \overline{n} ( {y}^{′} - \frac{{u}_{max , m}}{{k}_{r}} ) \vert}_{{z}^{′}}}}{{2 {n}_{o} + Δ \overline{n} ( {y}^{′} - \frac{{u}_{max , m}}{{k}_{r}} ) \vert}_{{z}^{′}}} ) {e}^{{- i {k}_{o} Δ \overline{n} ( {y}^{′} - \frac{{u}_{max , m}}{{k}_{r}} ) \vert}_{{z}^{′}} {x}_{c}} ] - [ {\sum }_{n} {C}_{min , n} exp [ - \frac{{u}_{min , n}^{2}}{{( {k}_{r} {w}_{o} )}^{2}} ] ( \frac{2 \sqrt{{{n}_{o} ( {n}_{o} + Δ \overline{n} ( {y}^{′} - \frac{{u}_{min , n}^{2}}{{k}_{r}} ) \vert}_{{z}^{′}}}}{{2 {n}_{o} + Δ \overline{n} ( {y}^{′} - \frac{{u}_{min , n}^{2}}{{k}_{r}} ) \vert}_{{z}^{′}}} ) {e}^{{- i {k}_{o} Δ \overline{n} ( {y}^{′} - \frac{{u}_{min , n}^{2}}{{k}_{r}} ) \vert}_{{z}^{′}} {x}_{c}} ] \qquad ( S8 )$$

FIG. 5B shows a data plot illustrating an approximated Bessel function, e.g., approximated by a series of delta functions at the maxima and minima. u_{max,m} and u_{min,n} are positions of mth maximum and nth minimum of Jₒ(u). c_{max,m}=J₀(u_{max,m}), c_{min,n}=J₀(u_{min,n}).

Representing Eₜ(y′)˜A−B in brief form, we can write the transmitted power through the slit as

$${{{{J}_{t} ( {y}^{′} ) \vert}_{{z}^{′}} ∝ {E}_{t}^{*} ( y ) \vert}_{z} , {E}_{t} ( {y}^{′} ) \vert}_{{z}^{′}} ∝ {AA}^{*} + B {B}^{*} - A {B}^{*} - B {A}^{*} \qquad ( S9 )$$

Next we analyze each term in (S9):

$$A {A}^{*} ( y ) ∼ [ {\sum }_{m , {m}^{′}} {C}_{max , m} {C}_{max , {m}^{′}} exp [ - \frac{{u}_{max , m}^{2} + {u}_{max , {m}^{′}}^{2}}{{( {k}_{r} {w}_{o} )}^{2}} ] ( \frac{2 \sqrt{{{n}_{o} ( {n}_{o} + Δ \overline{n} ( {y}^{′} - \frac{{u}_{max , m}^{2}}{{k}_{r}} ) \vert}_{{z}^{′}}}}{{2 {n}_{o} + Δ \overline{n} ( {y}^{′} - \frac{{u}_{max , m}^{2}}{{k}_{r}} ) \vert}_{{z}^{′}}} ) ( \frac{2 \sqrt{{{n}_{o} ( {n}_{o} + Δ \overline{n} ( {y}^{′} - \frac{{u}_{max , {m}^{′}}^{2}}{{k}_{r}} ) \vert}_{{z}^{′}}}}{{2 {n}_{o} + Δ \overline{n} ( {y}^{′} - \frac{{u}_{max , {m}^{′}}^{2}}{{k}_{r}} ) \vert}_{{z}^{′}}} ) ] {e}^{- i {k}_{o} [ Δ \overline{n} ( {y}^{′} - \frac{{u}_{max , m}^{2}}{{k}_{r}} ) - Δ \overline{n} ( {y}^{′} - \frac{{u}_{max , {m}^{′}}^{2}}{{k}_{r}} ) ] {x}_{c}} \qquad ( S10 )$$

It can be shown that the imaginary part of AA* is zero. Thus

$$A {A}^{*} ( y ) ∼ [ {\sum }_{m , {m}^{′}} {C}_{max , m} {C}_{max , {m}^{′}} exp [ - \frac{{u}_{max , m}^{2} + {u}_{max , {m}^{′}}^{2}}{{( {k}_{r} {w}_{o} )}^{2}} ] ( \frac{2 \sqrt{{{n}_{o} ( {n}_{o} + Δ \overline{n} ( {y}^{′} - \frac{{u}_{max , m}^{2}}{{k}_{r}} ) \vert}_{{z}^{′}}}}{{2 {n}_{o} + Δ \overline{n} ( {y}^{′} - \frac{{u}_{max , m}^{2}}{{k}_{r}} ) \vert}_{{z}^{′}}} ) ( \frac{2 \sqrt{{{n}_{o} ( {n}_{o} + Δ \overline{n} ( {y}^{′} - \frac{{u}_{max , {m}^{′}}^{2}}{{k}_{r}} ) \vert}_{{z}^{′}}}}{{2 {n}_{o} + Δ \overline{n} ( {y}^{′} - \frac{{u}_{max , {m}^{′}}^{2}}{{k}_{r}} ) \vert}_{{z}^{′}}} ) ] cos [ {k}_{o} [ Δ \overline{n} ( {y}^{′} - \frac{{u}_{max , m}^{2}}{{k}_{r}} ) - Δ \overline{n} ( {y}^{′} - \frac{{u}_{max , {m}^{′}}^{2}}{{k}_{r}} ) ] {x}_{c} ] \qquad ( S10 - A )$$

For m≠m′, the summation of the phase mismatched terms in (S10-A) leads to cancellation and produce small effects. Keeping the m=m′ terms only and having u_{max,m}=0=0 (i.e., the first max for the zero-order Bessel function is at the origin).

$$A {A}^{*} ( {y}^{′} ) ≅ \frac{4 {n}_{o} ( {n}_{o} + Δ \overline{n} ( {y}^{′} ) {\vert}_{z ′}}{{( 2 {n}_{o} + Δ \overline{n} ( {y}^{′} ) {\vert}_{z ′} )}^{2}} + [ {\sum }_{m \neq 0} {{C}_{max , m}}^{2} exp [ - \frac{2 {u}_{max , m}^{2}}{{( {k}_{r} {w}_{o} )}^{2}} ] \frac{4 {n}_{o} ( {n}_{o} + Δ \overline{n} ( {y}^{′} - \frac{{u}_{max , m}}{{k}_{r}} ) {\vert}_{z ′}}{{( 2 {n}_{o} + Δ \overline{n} ( {y}^{′} - \frac{{u}_{max , m}}{{k}_{r}} ) {\vert}_{z ′} )}^{2}} ] \qquad ( S10 - B )$$

Similarly, we have

$$B {B}^{*} ( {y}^{′} ) ∼ [ {\sum }_{n , n ′} {C}_{min , n} {C}_{min , n ′} exp [ - \frac{{u}_{min , n}^{2} + {u}_{min , n ′}^{2}}{{( {k}_{r} {w}_{o} )}^{2}} ] ( \frac{2 \sqrt{{n}_{o} ( {n}_{o} + Δ \overline{n} ( {y}^{′} - \frac{{u}_{min , n}}{{k}_{r}} ) {\vert}_{z ′}}}{2 {n}_{o} + Δ \overline{n} ( {y}^{′} - \frac{{u}_{min , n}}{{k}_{γ}} ) {\vert}_{z ′}} ) ( \frac{2 \sqrt{{n}_{o} ( {n}_{o} + Δ \overline{n} ( {y}^{′} - \frac{{u}_{min , n ′}}{{k}_{r}} ) {\vert}_{z ′}}}{2 {n}_{o} + Δ \overline{n} ( {y}^{′} - \frac{{u}_{min , {n}^{′}}}{{k}_{r}} ) {\vert}_{z ′}} ) ] {e}^{- i {k}_{o} [ Δ \overline{n} ( {y}^{′} - \frac{{u}_{min , n}}{{k}_{r}} ) - Δ \overline{n} ( {y}^{′} - \frac{{u}_{min , {n}^{′}}}{{k}_{r}} ) ] {x}_{c}} \qquad ( S11 )$$

$${BB}^{*} ( {y}^{′} ) ∼ [ {\sum }_{n , {n}^{′}} {C}_{min , n} {C}_{min , n ′} exp [ - \frac{{u}_{min , n}^{2} + {u}_{min , n ′}^{2}}{{( {k}_{r} {w}_{o} )}^{2}} ] ( \frac{2 \sqrt{{n}_{o} ( {n}_{o} + Δ \overline{n} ( {y}^{′} - \frac{{u}_{min , n}}{{k}_{r}} ) {\vert}_{z ′}}}{2 {n}_{o} + Δ \overline{n} ( {y}^{′} - \frac{{u}_{min , n}}{{k}_{r}} ) {\vert}_{z ′}} ) \frac{2 \sqrt{{n}_{o} ( {n}_{o} + Δ \overline{n} ( {y}^{′} - \frac{{u}_{min , n ′}}{{k}_{r}} ) {\vert}_{z ′}}}{2 {n}_{o} + Δ \overline{n} ( {y}^{′} - \frac{{u}_{min , n ′}}{{k}_{r}} ) {\vert}_{z ′}} ) ] co s [ {k}_{o} [ Δ \overline{n} ( {y}^{′} - \frac{{u}_{min , n}}{{k}_{r}} ) - Δ \overline{n} ( {y}^{′} - \frac{{u}_{min , n ′}}{{k}_{r}} ) ] {x}_{c} ] \qquad ( S11 - A )$$

For the same argument as before, we take only the terms where n=n′, then (S11-A) can be represented approximately as

$$B {B}^{*} ( {y}^{′} ) ≅ [ {\sum }_{n} {{C}_{min , n}}^{2} exp [ - \frac{2 {u}_{min , n}^{2}}{{( {k}_{r} {w}_{o} )}^{2}} ] \frac{4 {n}_{o} ( {n}_{o} + Δ \overline{n} ( {y}^{′} - \frac{{u}_{min , n}}{{k}_{r}} ) {\vert}_{z ′}}{{( 2 {n}_{o} + Δ \overline{n} ( {y}^{′} - \frac{{u}_{min , n}}{{k}_{r}} ) {\vert}_{z ′} )}^{2}} ] \qquad ( S11 - B )$$

Similarly,

$${AB}^{*} ( {y}^{′} ) ∼ [ {\sum }_{m , n ′} {C}_{max , m} {C}_{min , n ′} exp [ - \frac{{u}_{max , m}^{2} + {u}_{min , n ′}^{2}}{{( {k}_{r} {w}_{o} )}^{2}} ] ( \frac{2 \sqrt{{n}_{o} ( {n}_{o} + Δ \overline{n} ( {y}^{′} - \frac{{u}_{max , m}}{{k}_{r}} ) {\vert}_{z ′}}}{2 {n}_{o} + Δ \overline{n} ( {y}^{′} - \frac{{u}_{max , m}}{{k}_{r}} ) {\vert}_{z ′}} ) ( \frac{2 \sqrt{{n}_{o} ( {n}_{o} + Δ \overline{n} ( {y}^{′} - \frac{{u}_{min , n ′}}{{k}_{r}} ) {\vert}_{z ′}}}{2 {n}_{o} + Δ \overline{n} ( {y}^{′} - \frac{{u}_{min , n ′}}{{k}_{r}} ) {\vert}_{z ′}} ) ] {e}^{- i {k}_{o} [ Δ \overline{n} ( {y}^{′} - \frac{{u}_{max , m}}{{k}_{r}} ) - Δ \overline{n} ( {y}^{′} - \frac{{u}_{min , n ′}}{{k}_{r}} ) ] {x}_{c}} \qquad ( S12 )$$

$${AB}^{*} ( {y}^{′} ) ∼ [ {\sum }_{m , n ′} {C}_{max , m} {C}_{min , n ′} exp [ - \frac{{u}_{max , m}^{2} + {u}_{min , n ′}^{2}}{{( {k}_{r} {w}_{o} )}^{2}} ] ( \frac{2 \sqrt{{n}_{o} ( {n}_{o} + Δ \overline{n} ( {y}^{′} - \frac{{u}_{max , m}}{{k}_{r}} ) {\vert}_{z ′}}}{2 {n}_{o} + Δ \overline{n} ( {y}^{′} - \frac{{u}_{max , m}}{{k}_{r}} ) {\vert}_{z ′}} ) ( \frac{2 \sqrt{{n}_{o} ( {n}_{o} + Δ \overline{n} ( {y}^{′} - \frac{{u}_{min , n ′}}{{k}_{r}} ) {\vert}_{z ′}}}{2 {n}_{o} + Δ \overline{n} ( {y}^{′} - \frac{{u}_{min , n ′}}{{k}_{r}} ) {\vert}_{z ′}} ) ] cos [ {k}_{o} [ Δ \overline{n} ( {y}^{′} - \frac{{u}_{max , m}}{{k}_{r}} ) - Δ \overline{n} ( {y}^{′} - \frac{{u}_{min , n ′}}{{k}_{r}} ) ] {x}_{c} ] \qquad ( S12 - A )$$

For the same argument as above, we have AB*(y′)˜0, since the cos terms contain random phases.

$$B {A}^{*} ( {y}^{′} ) ∼ [ {\sum }_{m , n ′} {C}_{max , m} {C}_{min , n ′} exp [ - \frac{{u}_{min , n}^{2} + {u}_{max , m ′}^{2}}{{( {k}_{r} {w}_{o} )}^{2}} ] ( \frac{2 \sqrt{{n}_{o} ( {n}_{o} + Δ \overline{n} ( {y}^{′} - \frac{{u}_{min , n}}{{k}_{r}} ) {\vert}_{z ′}}}{2 {n}_{o} + Δ \overline{n} ( {y}^{′} - \frac{{u}_{min , n}}{{k}_{r}} ) {\vert}_{z ′}} ) ( \frac{2 \sqrt{{n}_{o} ( {n}_{o} + Δ \overline{n} ( {y}^{′} - \frac{{u}_{max , m ′}}{{k}_{r}} ) {\vert}_{z ′}}}{2 {n}_{o} + Δ \overline{n} ( {y}^{′} - \frac{{u}_{max , {m}^{′}}}{{k}_{r}} ) {\vert}_{z ′}} ) ] {e}^{- i {k}_{o} [ Δ \overline{n} ( {y}^{′} - \frac{{u}_{min , n ′}}{{k}_{r}} ) - Δ \overline{n} ( {y}^{′} - \frac{{u}_{max , m ′}}{{k}_{r}} ) ] {x}_{c}} \qquad ( S13 )$$

For the same reason above, BA′(y′)˜0.

As a result, we have

$${J}_{t} ( {y}^{′} , x ) ∼ \frac{4 {n}_{o} ( {n}_{o} + Δ \overline{n} ( {y}^{′} ) {\vert}_{z ′}}{{( 2 {n}_{o} + Δ \overline{n} ( {y}^{′} ) {\vert}_{z ′} )}^{2}} + [ {\sum }_{m \neq 0} {{C}_{max , m}}^{2} exp [ - \frac{2 {u}_{max , m}^{2}}{{( {k}_{r} {w}_{o} )}^{2}} ] \frac{4 {n}_{o} ( {n}_{o} + Δ \overline{n} ( {y}^{′} - \frac{{u}_{max , m}}{{k}_{r}} ) {\vert}_{z ′}}{{( 2 {n}_{o} + Δ \overline{n} ( {y}^{′} - \frac{{u}_{max , m}}{{k}_{r}} ) {\vert}_{z ′} )}^{2}} ] + [ {\sum }_{n} {{C}_{min , n}}^{2} exp [ - \frac{2 {u}_{min , n}^{2}}{{( {k}_{r} {w}_{o} )}^{2}} ] \frac{4 {n}_{o} ( {n}_{o} + Δ \overline{n} ( {y}^{′} - \frac{{u}_{min , n}}{{k}_{r}} ) {\vert}_{z ′}}{{( 2 {n}_{o} + Δ \overline{n} ( {y}^{′} - \frac{{u}_{min , n}}{{k}_{r}} ) {\vert}_{z ′} )}^{2}} ] \qquad ( S14 )$$

Define

$$f ( y , z ) = \frac{4 {n}_{o} ( {n}_{o} + Δ \overline{n} ( y )}{{( 2 {n}_{o} + Δ \overline{n} ( y ) )}^{2}} {\vert}_{z} .$$

By solving f(y,z), we can obtain the index profile of the object Δn̅(y,z).

According to (S14), we have

$${J}_{t} ( {y}^{′} , {z}^{′} ) = f ( {y}^{′} , {z}^{′} ) + [ {\sum }_{m \neq 0} {{C}_{max , m}}^{2} exp [ - \frac{2 {u}_{max , m}^{2}}{{( {k}_{r} {w}_{o} )}^{2}} ] f ( {y}^{′} - \frac{{u}_{max , m}}{{k}_{r}} , {z}^{′} ) ] + [ {\sum }_{n} {{C}_{min , n}}^{2} exp [ - \frac{2 {u}_{min , n}^{2}}{{( {k}_{r} {w}_{o} )}^{2}} ] f ( {y}^{′} - \frac{{u}_{min , n}}{{k}_{r}} , {z}^{′} ) ] = f ( {y}^{′} , {z}^{′} ) + [ {\sum }_{m \neq 0} {{a}_{max , m}}^{2} f ( {y}^{′} - \frac{{u}_{max , m}}{{k}_{r}} , {z}^{′} ) ] + [ {\sum }_{n} {{a}_{min , n}}^{2} f ( {y}^{′} - \frac{{u}_{min , n}}{{k}_{r}} , {z}^{′} ) ] \qquad ( S15 )$$

$$\begin{matrix}{{a}_{max , m}}^{2} = {{C}_{max , m}}^{2} {e}^{- \frac{{}^{2 u} max , {m}^{2}}{{k}_{r}^{2} {W}_{o}^{2}}} & m = \pm 1 , \pm 2 , \pm 3 , …\end{matrix} \qquad ( S16 - a )$$

$$\begin{matrix}{{a}_{min , m}}^{2} = {{C}_{min , n}}^{2} {e}^{- \frac{{}^{2 u} min , {n}^{2}}{{k}_{r}^{2} {W}_{o}^{2}}} & n = \pm 1 , \pm 2 , \pm 3 , …\end{matrix} \qquad ( S16 - b )$$

Next, this disclosure discusses how to determine the limits of m and n in (S15). We assume the scanning range of the laser beam is from −L_{y}/2 to L_{y}/2, and the laser beam spot covers a range from −W_{y}/2 to +W_{y}/2 due to the side lobes of the Bessel-Gaussian beam. Assume a scanning rate of 200 kHz and a sampling rate of 25 MS/s, we have 125 sampling points for each scan corresponding to the beam center position.

We assume the width of the side lobes of a Bessel-Gaussian beam is W_{y}. The transmitted light intensity becomes nonzero when

$$- \frac{{W}_{y}}{2} < {y}^{′} - y < \frac{{W}_{y}}{2} .$$

### Then

$$- \frac{{L}_{y}}{2} - \frac{{W}_{y}}{2} < y < \frac{{L}_{y}}{2} + \frac{{W}_{y}}{2} \qquad ( S17 )$$

Equation (S17) defines the integration range for (S15). In other words, we need to integrate at least over this range defined in (S17) to restore the object image from the measured data in each scan.

The dimension of the T-matrix we will discuss next would be a

$$\{ 12 \; 5 [ 1 + \frac{{W}_{y}}{{L}_{y}} ] + 1 \} \times \{ 125 [ 1 + \frac{{W}_{y}}{{L}_{y}} ] + 1 \}$$

matrix. If we choose

$$\frac{{W}_{y}}{{L}_{y}} = 1 ,$$

then the T-matrix is a 251×251 matrix.

We write Jₜ(y′,z′) into a column matrix with 125 non-zero elements defined by the “width” of the Bessel-Gaussian beam. Arbitrarily, we choose these 125 nontrivial points in an index range from −2 to 122, as shown in (S18). Outside this range, we define the “padding values” B=Jₜ (y′₀,z′) and B′=Jₜ(y′₁₂₀,z′).

$${[ \begin{matrix}B \\ … \\ B \\ {J}_{t} ( {y}_{- 2}^{′} , {z}^{′} ) \\ {J}_{t} ( {y}_{- 1}^{′} , {z}^{′} ) \\ {J}_{t} ( {y}_{0}^{′} , {z}^{′} ) \\ {J}_{t} ( {y}_{1}^{′} , {z}^{′} ) \\ {J}_{t} ( {y}_{2}^{′} , {z}^{′} ) \\ ⋮ \\ {J}_{t} ( {y}_{120}^{′} , {z}^{′} ) \\ {J}_{t} ( {y}_{121}^{′} , {z}^{′} ) \\ {J}_{t} ( {y}_{122}^{′} , {z}^{′} ) \\ {B}^{′} \\ {B}^{′} \\ … \\ {B}^{′}\end{matrix} ]}_{251 \times 1} = {{[ T ]}_{251 \times 251} [ \begin{matrix}f ( {y}_{- 65}^{′} , {z}^{′} ) \\ … \\ f ( {y}_{- 3}^{′} , {z}^{′} ) \\ f ( {y}_{- 2}^{′} , {z}^{′} ) \\ f ( {y}_{- 1}^{′} , {z}^{′} ) \\ f ( {y}_{0}^{′} , {z}^{′} ) \\ f ( {y}_{1}^{′} , {z}^{′} ) \\ f ( {y}_{2}^{′} , {z}^{′} ) \\ ⋮ \\ f ( {y}_{120}^{′} , {z}^{′} ) \\ f ( {y}_{121}^{′} , {z}^{′} ) \\ f ( {y}_{122}^{′} , {z}^{′} ) \\ f ( {y}_{123}^{′} , {z}^{′} ) \\ f ( {y}_{124}^{′} , {z}^{′} ) \\ … \\ f ( {y}_{185}^{′} , {z}^{′} )\end{matrix} ]}_{251 \times 1} \qquad ( S18 )$$

Jₜ(y′₀,z′), . . . , Jₜ(y′₁₂₀,z′) and f(y′₀,z′) . . . , f(y′₁₂₀,z′) are within the “chosen” field of view. Jₜ(y′₋₂,z′), Jₜ(y′₋₁,z′), Jₜ(y′₁₂₁,z′), Jₜ(y′₁₂₂,z′) are measured signal within the laser scanning range. The reason why we have nontrivial f(y′₋₆₅,z′), . . . , f(y′₋₃,z′) and f(y′₁₂₃,z′), . . . , f(y′₁₈₅,z′) is because the side lobes of the Bessel-Gaussian beam can illuminate objects outside the field of view.

Calculating the inverse of the T-matrix, we can solve f(y′,z′)

$${[ \begin{matrix}f ( {y}_{- 65}^{′} , {z}^{′} ) \\ … \\ f ( {y}_{- 3}^{′} , {z}^{′} ) \\ f ( {y}_{- 2}^{′} , {z}^{′} ) \\ f ( {y}_{- 1}^{′} , {z}^{′} ) \\ f ( {y}_{0}^{′} , {z}^{′} ) \\ f ( {y}_{1}^{′} , {z}^{′} ) \\ f ( {y}_{2}^{′} , {z}^{′} ) \\ ⋮ \\ f ( {y}_{120}^{′} , {z}^{′} ) \\ f ( {y}_{121}^{′} , {z}^{′} ) \\ f ( {y}_{122}^{′} , {z}^{′} ) \\ f ( {y}_{123}^{′} , {z}^{′} ) \\ f ( {y}_{124}^{′} , {z}^{′} ) \\ … \\ f ( {y}_{185}^{′} , {z}^{′} )\end{matrix} ]}_{251 \times 1} = {{[ T ]}_{251 \times 251}^{- 1} [ \begin{matrix}B \\ … \\ B \\ {J}_{t} ( {y}_{- 2}^{′} , {z}^{′} ) \\ {J}_{t} ( {y}_{- 1}^{′} , {z}^{′} ) \\ {J}_{t} ( {y}_{0}^{′} , {z}^{′} ) \\ {J}_{t} ( {y}_{1}^{′} , {z}^{′} ) \\ {J}_{t} ( {y}_{2}^{′} , {z}^{′} ) \\ ⋮ \\ {J}_{t} ( {y}_{120}^{′} , {z}^{′} ) \\ {J}_{t} ( {y}_{121}^{′} , {z}^{′} ) \\ {J}_{t} ( {y}_{122}^{′} , {z}^{′} ) \\ {B}^{′} \\ {B}^{′} \\ … \\ {B}^{′}\end{matrix} ]}_{251 \times 1} \qquad ( S19 )$$

The elements of the T-matrix are defined as follow:

$$\begin{matrix}{T}_{ij} = 1. & if i = j , & - 65 \leq i , j \leq 185\end{matrix} \qquad ( S20 )$$

$${T}_{ij} = {C}_{l}^{2} exp [ - \frac{2 {u}_{l}^{2}}{{( {k}_{r} {w}_{o} )}^{2}} ] ≡ {a}_{l}^{2} where {u}_{l} is the lth min or max for {J}_{0} ( u ) if {y}_{i}^{′} - \frac{{u}_{l}}{{k}_{r}} = {y}_{j}^{′}$$

$${T}_{i j} = 0. \qquad otherwise$$

Equations (S19) and (S20) describe how we reconstruct the transmission images for cells or beads from the PMT signal.

### II. Example Preparation

### Culture of AML Cells:

SKNO-1 leukemia cells are thawed and seeded out at a concentration of ˜0.5×10⁶ cells/ml. They were incubated at 37° C., 5% CO₂ in culture medium (90% RPMI-1640+10% FBS+1% PS). We split the cells by 1:2 to 1:3 every 2-3 days when they were close to the maximum density (˜2.5×10⁶ cells/ml). Before the sorting experiment, we collected the cells from medium by centrifuge, then resuspended them in PBS and they were ready for the experiment.

### Preparation of Normal White Blood Cells:

Whole blood from healthy donors were provided by San Diego Blood Bank. The following steps were performed to lyse the red blood cells and to collect the white blood cells from whole blood:
1. Add 1 ml of whole blood to a 15 ml conical tube.
2. Add 10 ml of 1× Lysis Buffer (Invitrogen, 00-4333-57) to the tube.
3. Incubate for 12 mins at room temperature.
4. Spin at 400 g for 6 mins.
5. Pipette out supernatant, making sure to leave no red layer in the tube.
6. Add 5 ml of 1× Lysis buffer and wash at 400 g.
7. Pipette out supernatant, making sure to leave no red layer in the tube.
8. Dilute sample with PBS to desired concentration. The sample should contain all WBCs and is ready for the experiment.

### Wright-Giemsa Staining of White Blood Cells/Leukemia Cells on Membrane Filter

1. Let the cells dry on the membrane filter.
2. Fix cells by placing them in pure Methanol for 5 minutes.
3. Place the membrane filter in a staining tray and immerse it in Working Wright Giemsa Solution for 5 minutes.
4. Rinse the cells in deionized/distilled water.
5. Flood with Phosphate Buffer Solution, pH 6.8 until no stain runs off. Allow the membrane filter to remain in pH 6.8 PBS for an additional 1 minute.
6. Dip the membrane filter in distilled water and air dry at room temperature.
7. Dip the membrane filter in Xylene or Xylene Substitute several times.
8. Put the membrane filter on a glass slide and mount it in synthetic resin.

### E. Waveform-Based Real-Time Sorting

The mathematical algorithm in the previous section can recover the object image from the PMT signal. However, the computation of 251×251 matrix multiplication is time-consuming and can limit the throughput. On the other hand, because most cell features, including size, spottiness, granularity, etc., are encoded in the PMT output waveform, we can extract many image features that differentiate cell types directly from the temporal waveform without reconstructing the 2D cell images. This saves tremendous computation time and resources, and the method is suitable for cell sorting by image features. For all sorting experiments reported in this paper, we define gating based on the characteristics of the temporal waveform, which are closely correlated to specific image features. We then use the mathematical algorithm discussed in the previous section to reconstruct the cell transmission images off-line for verification purposes. To quantify sorting accuracy, we also apply additional methods such as staining and microscopy to verify the performance of waveform-based image-guided cell sorting.

FIGS. 5C and 5D show data plots and images depicting transmission PMT signals for 15 μm and 7 μm beads and reconstructed images. The example data shown in FIGS. 5C and 5D demonstrate an example of how the temporal waveform carries features about particle size and how we can use the waveform features to distinguish 15 μm and 7 μm diameter beads. When there is no object in the microfluidic channel, the scanning Bessel-Gaussian beam transmits through the slit and the PMT shows a periodic background signal, caused by any imperfections or dust particles in the COC microfluidic chip intersected by the laser beam. Since these features are still, they appear to be periodic in each scan and can be subtracted by software. When a cell or bead travels through the optical interrogation area, it creates an instantaneous change in the PMT output signal on top of the background.

The PMT waveforms in FIGS. 5C panel (i) and 5D panel (i) show an envelope with a series of spikes. Each spike represents a single scan spanning a duration of 5 μs, and the width of the spike is proportional to the size of the bead along the scanning (y-) direction. On the other hand, the width of the overall signal envelope is proportional to the dimension of the bead in the flow direction after correction of the effect of the flow speed. Based on this argument, we develop the following sorting criterion that is equivalent to the particle size.

We find the time interval between the first negative peak and the last negative peak T₁, which corresponds to the duration when the bead crosses the optical interrogation zone defined by the width of the slit in the spatial mask. The bead length L along the flow direction equals T₁*v_{bead}, where v_{bead} is bead traveling speed. We then analyze the detailed waveform of each 5 μs scan (labelled by “*” in the envelope waveform) to find the bead dimension in the scanning direction. FIGS. 5C panel (ii) and 5D panel (ii) show the detailed waveform of each 5 μs scan at a given z position. By slicing the object into N sections along the z-position, the object width at the n^{th} section can be represented as T₂ⁿ*v_{scan} with n being the index of the z-position and v_{scan} is the beam scanning speed (v_{scan}=8 m/s). FIG. 5C panel (ii) shows two (10^{th} and 16^{th}) of such scans for a 15 μm bead. The 10^{th} scan gives the largest value of T₂ⁿ*v_{scan}, indicating the widest part (e.g., diameter) of the bead. Similar characteristics can be found in the waveform of 7 μm beads. The above example demonstrates how one can relate the temporal waveform features to the geometric features of a travelling object such as size, shape, aspect ratio, etc.

In the data plots and images of FIGS. 5C and 5D depicting transmission PMT signals for 15 μm and 7 μm beads and reconstructed images, panel (i) represented the overall signals, where each “*” represents the peak of each scan. The product of the bead speed v_{bead} and the width of the overall envelope T₁ is proportional to the bead dimension along the flow direction. Panel (ii) of FIGS. 5C and 5D represent detailed waveforms for a single 5 μs AOD scan. At each specific z-position, the dimension of the bead along the scanning direction is T₂*v_{scan} where v_{scan}=8 m/s is the beam scanning speed. Panel (iii) of FIS. 5C and 5D represent reconstructed transmission images of a 15 μm and 7 μm bead. The relations between the temporal waveforms and the image features are also indicated in the figures.

Example Results from Example Implementations

### Sorting of 10 and 15 μm Beads

To validate the sorting algorithm described above, a sorting experiment was done using 7 μm, 10 μm and 15 μm beads.

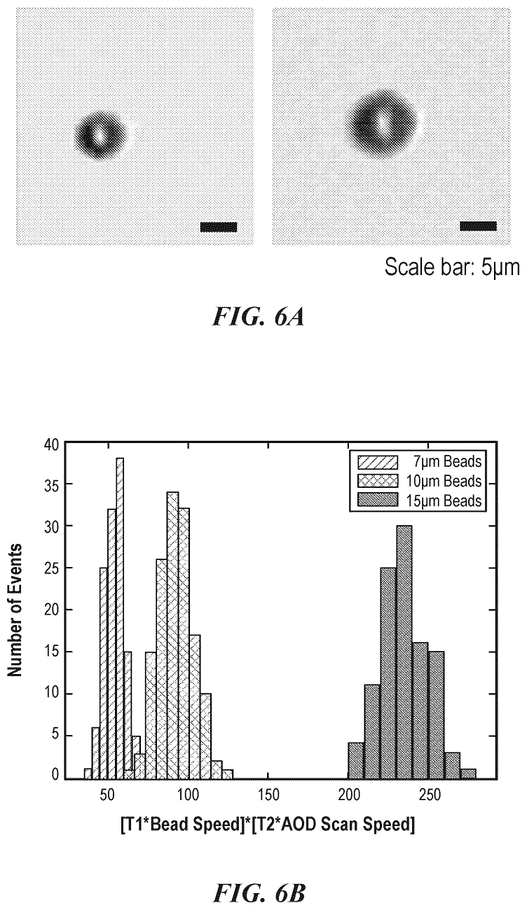

FIGS. 6A and 6B show images and histograms of polystyrene beads generated by the Bessel-Gaussian beam image-guided cell sorter. FIG. 6A: Transmission images of polystyrene beads with 7 μm (left) and 10 μm (right) diameter; scale bar: 5 μm. FIG. 6B: Histogram of (T₁*v_{bead})*(T₂*v_{scan}) for 7 μm, 10 μm and 15 μm beads.

To evaluate sorting performance, we sorted 10 μm beads from a 1:1 mixture of 7 μm and 10 μm beads, as well as 15 μm beads from a 1:1 mixture of 7 μm and 15 μm beads. The sorted beads were imaged using a microscope to verify the sorting accuracy. The first experiment demonstrated a sorting purity of 97%, verified by 233 microscope images; and the second experiment demonstrated 100% sorting purity, verified by 173 microscope images.

### Label-Free Sorting of Leukemia Cells

Blood cancers such as acute myeloid leukemia (AML) are estimated to account for 9.9% of the 1.8 million new cancer cases diagnosed in 2020. Leukemia, lymphoma and myeloma are expected to account for 9.4% of all cancer deaths in 2020.

Acute myeloid leukemia is derived from the myeloid line of blood cells and is characterized by its rapid and unchecked growth of abnormal cells in the bone marrow that interferes with normal blood cell production. Diagnosis usually occurs via bone marrow aspiration or antibody-specific blood tests. However, these require costly panels and tedious procedures. An image-guided cell sorter enables the identification and subsequent sorting of AML cells without any antibody or fluorescent labeling, aiding early detection and eliminating the need for costly reagents and tedious laboratory procedures.

In an example proof-of-concept experiment, patient-derived SKNO1 acute myeloid leukemia (AML) cells were cultured in cell culture media (90% RPMI+8% FBS+1% penicillin+1% streptomycin) at 37° C. with 5% CO₂. The SKNO1 cells were spiked into white blood cells from healthy donors (San Diego Blood Bank, 3636 Gateway Center Ave Suite 100, San Diego). A number of feature parameters were extracted from the transmission waveform of these cells, which are intuitively related to cell area, perimeter, granularity, roughness, contrast, and texture. The most distinguishing features between SKNO1 cells and white blood cells were determined to be T₁*v_{cell} and the number of positive peaks of the waveform. The former is related to cell size and the latter to intracellular granularity. To demonstrate image-guided label-free cell sorting, a 2D plot of these parameters was generated and the appropriate gating parameters were chosen to sort SKNO1 cells from healthy white blood cells in a ratio of 1:50. To evaluate the cell sorting, Wright-Giemsa staining was performed. The full details for the staining procedure can be found in the supplementary material. The sorted cells were collected in a tube and deposited on a polyester transparent membrane filter (1300019, Sterlitech). Wright-Giemsa staining was performed and the stained cells were imaged using brightfield microscopy. A total of 124 SKNO1 cells were imaged from a total of 128 cells found on the membrane, giving rise to a sorting purity of 97%. Given the initial population of 2% SKNO1 cells, the sorting has enriched the sample by 1600 times.

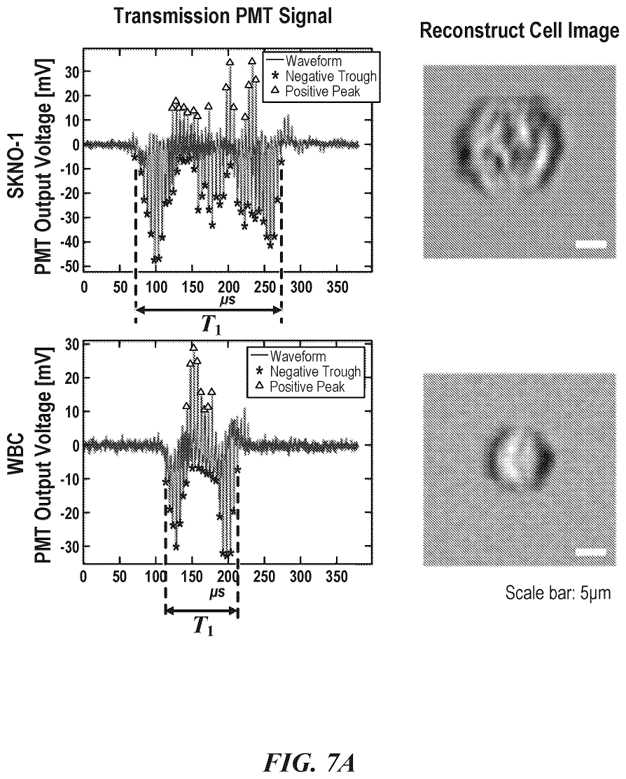

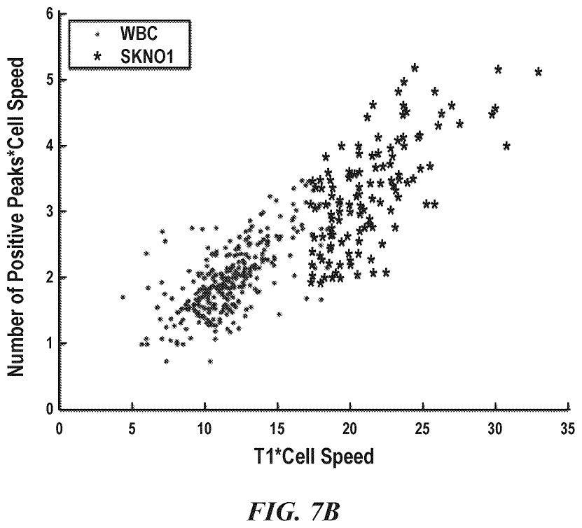

FIGS. 7A and 7B show data plots and images depicting results of example implementations. FIG. 7A shows data plots and images, including transmission PMT signals and images for SKNO-1 and WBC generated by the Bessel-Gaussian beam image-guided cell sorter (e.g., scale bar: 5 μm). FIG. 7B shows a data plot, including distribution plots using these two parameters: T₁*v_{cell} and N*v_{cell} where N is the number of positive peaks in the PMT waveform. Multiplication of cell speed to both parameters removes feature distortions due to cell speed variations.

### Label-Free Sorting of Scenedesmus sp.

Algae are a group of photosynthetic, eukaryotic organisms that can be found in oceans, waterways, lakes, and soils all over the world. Algae are commonly used to monitor environmental changes and have a number of industrial uses, including the production of biodiesel, ceramic products, glass products; in wastewater and oil spill cleanup; and in the biotechnology field as anticoagulant, antiviral and antitumor agents. Despite their usefulness, little is known regarding the majority of these algae, with the estimated number of microalgae species exceeding one million. In comparison, the best algae culture collections often contain only a few thousand species. Isolation of microalgae species from the environment is a useful and necessary approach to understanding these organisms and uncovering potential technological solutions. Traditionally, these organisms are isolated by hand using micropipettes or capillary tubes, or by fluorescence-activated cell sorting, and are subsequently cultured. However, the throughput and usefulness of these approaches are limited, as microalgae and other microorganisms experience complex relationships with surrounding organisms that affect algae phenotype.

Scenedesmus sp. is one of the most common freshwater green algae. These colonial, non-motile algae have been researched for its high biomass productivity and its efficiency at capturing CO₂. Scenedesmus is capable of producing many types of biofuels and has been most extensively studied for biodiesel production. As there are over seventy taxonomically accepted species of Scenedesmus, including some with unique properties that only exist in local populations, the high-throughput identification and sorting of these algae from field-collected samples could unlock new opportunities.

As an example proof-of-concept sorting experiment, Scenedesmus (Carolina Biological Supply, 152510) were spiked into field-collected microorganisms (Miramar Lake, San Diego, California) in a ratio of 1:5. The sample was run through a 35 μm filter to remove clumps and large particles. The distinguishing feature of Scenedesmus from the other microorganisms was T₁*v_{algae}, which intuitively relates to size. A histogram with these parameters was generated and the appropriate portion was gated. The sorted samples were collected into tubes and visualized using brightfield microscopy. From a total of 253 sorted cells verified by microscope, 248 of them were Scenedesmus and 5 were other microorganisms, resulting in a sorting purity of 98%.

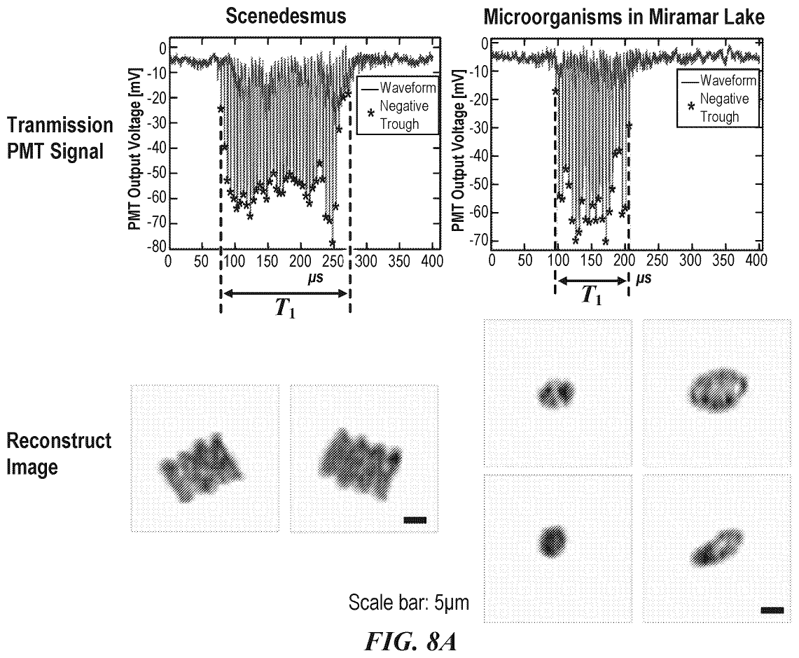

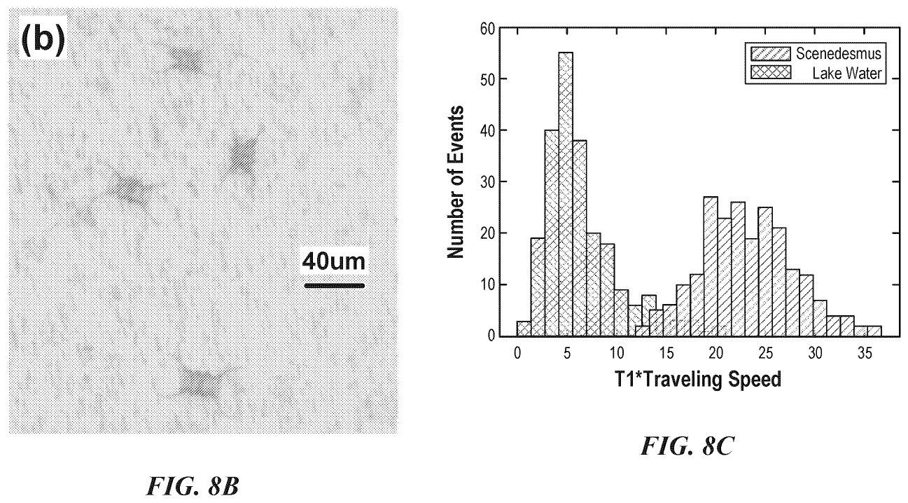

FIGS. 8A-8C show data plots and images, including (FIG. 8A) Transmission channel waveforms and reconstructed images of Scenedesmus and microorganisms in Miramar Lake water (e.g., scale bar: 5 μm); (FIG. 8B) Optical microscope images of Scenedesmus being sorted on membrane filter; and (FIG. 8C) Histogram of T₁*v_{algae} for Scenedesmus and other microorganisms in lake water.

### Discussion of Example Implementations

Leveraging the unique properties of Bessel beam illumination, we present a microfluidic, label-free image-guided cell sorter with an ultra-long depth of focus, resulting in a threefold increase in the number of in-focus cells compared with Gaussian beam systems. Proof-of-concept experiments were demonstrated with high sorting purity using the label-free transmission waveform features as sorting criteria. For the sorting of polystyrene beads, SKNO1 leukemia cells, and Scenedesmus green algae, our results indicate a sorting purity of 97%, 97%, and 98%, respectively. Because of the side lobes inherent to the Bessel beam, a significant amount of computation is required to restore the cell image from the measured temporal signal, and this computation time can limit the throughput. The current system keeps refreshing the cell images for data visualization with a processing time of ˜3 ms using FPGA processor (Xilinx Kintex-7 XC7K410T). It is estimated that the image processing time can be reduced to less than 500 us by using a more powerful FPGA such as Xilinx Virtex XCVU440.

By approximating the zero-order Bessel function by a series of delta functions at its maxima and minima, we have developed an effective mathematical algorithm to restore the cell image from the waveform. The restored images have shown sufficient quality to allow users to visualize the object that is being analyzed and sorted. More importantly, we have demonstrated the method of using the waveform features as gating criteria to sort cells with superior sorting purity, utilizing the close relations between the waveform features and the image features. The successful demonstration of this approach eliminates the need for real-time image reconstruction, greatly reducing the computation resource and time delay. On the other hand, the ability to restore the cell images from the waveform in an off-line process facilitates the human-machine interface, enhancing the operability and user-friendliness of the system.

### EXAMPLES

In some embodiments in accordance with the present technology (example 1), an image-based particle sorting system includes an optical imaging system, including (i) a light source to produce an excitation beam, (ii) an optical shape-forming device to modify a shape of the excitation beam to have an increased focal depth that is to be directed at an interrogation area of a particle-flow channel, (iii) an optical scanning device to scan for one or more light beams at the interrogation area, (iv) one or more spatial filters arranged in an optical path of the directed shape-modified excitation beam, and (v) one or more optical detectors to obtain image data of individual particles flowing in a carrier fluid through the interrogation area of the particle flow device from the one or more scanned light beams; a data processing system comprising at least one processor and at least one memory and in communication with the optical imaging system and configured to process the image data obtained by the optical imaging device to determine one or more properties associated with the individual particles flowing in the carrier fluid and to produce a control command based on a comparison of the determined one or more properties with a sorting criteria, wherein the control command is produced in real time during flowing of the individual particles in the particle-flow channel; and a particle sorting system in communication with the data processing system and disposed in the optical path of the optical imaging system, the particle sorting system including a particle flow device and an actuator device operably coupled to the particle flow device, wherein the particle flow device comprises a substrate including the particle-flow channel and a plurality of output channels branching from the particle-flow channel to receive, in one output channel of the plurality of output channels, sorted particles directed by the actuator device based on the control command.

Example 2 includes the system of any of examples 1-27, wherein the control command produced by the data processing system in real time is indicative of a sorting decision created in real time based on one or more attributes of the individual particles ascertained from the image data.

Example 3 includes the system of any of examples 1-27, wherein the sorting criteria includes one or more threshold properties of a particle corresponding to one or more of (i) an amount and/or a size of a sub-feature of or on an individual particle; (ii) an amount and/or size of the individual particle itself; (iii) a morphology characteristic of the sub-feature of the individual particle; or (iv) a morphological characteristic of the individual particle itself.

Example 4 includes the system of example 3 or any of examples 1-27, wherein the sorting criteria is predetermined, and wherein the data processing system is in communication with a remote computing device to receive a programmable command to adjust the sorting criteria from the client device.

Example 5 includes the system of any of examples 1-27, wherein the shape-modified excitation beam is a Bessel-Gaussian beam.

Example 6 includes the system of example 5 or any of examples 1-27, wherein the Bessel-Gaussian beam has an increased focal depth of the individual particles in the obtained image data by 80% to 95% with respect to a Gaussian excitation laser beam.

Example 7 includes the system of any of examples 1-27, wherein the particle flow device includes a microfluidic chip.

Example 8 includes the system of any of examples 1-27, wherein the actuator device includes a piezoelectric actuator.

Example 9 includes the system of any of examples 1-27, wherein the optical shape-forming device includes an axicon.

Example 10 includes the system of any of examples 1-27, wherein the light source includes a laser.

Example 11 includes the system of example 10 or any of examples 1-27, wherein the laser includes a 488 nm laser.

Example 12 includes the system of example 10 or any of examples 1-27, wherein the optical scanning device includes an acousto-optic deflector (AOD).

Example 13 includes the system of example 12 or any of examples 1-27, wherein the one or more optical detectors includes a photomultiplier tube (PMT) detector.

Example 14 includes the system of example 13 or any of examples 1-27, wherein the spatial mask includes a first spatial mask having one slit, and wherein the data processing system is configured to encode a two-dimensional transmission profile of an individual particle obtained from the PMT detector into a temporal signal capable of being compared to the sorting criteria such that the individual particle is by the actuator device based on the control command.

Example 15 includes the system of example 14 or any of examples 1-27, wherein the first spatial mask includes one slit, and wherein the first spatial mask is disposed at an image plane such that the one slit is aligned to the center of a Bessel-Gaussian beam to create an imaging area at a focal plane, wherein the first spatial mask is operable to block sidelobes of the Bessel-Gaussian beam along a flow direction of the individual particle while the sidelobes along a scanning direction perpendicular to the flow direction are able to pass the first spatial mask.

Example 16 includes the system of example 15 or any of examples 1-27, wherein the one slit of the first spatial mask includes a 500 μm×15 μm slit, and wherein the imaging area at the focal plane is created to be a 50 μm×1.5 μm area.

Example 17 includes the system of any of examples 1-27, wherein the optical imaging system further includes one or more optical components to direct and/or manipulate the excitation beam in the optical path at the interrogation area of the particle-flow channel of the particle flow device.

Example 18 includes the system of example 17 or any of examples 1-27, wherein the one or more optical components to direct and/or manipulate light include one or more lenses, one or more mirrors, one or more dichroic mirrors, and one or more objective lenses.

Example 19 includes the system of example 18 or any of examples 1-27, wherein the one or more objective lenses include one or both of an illumination objective lens (IL) and a detection objective lens (DL).

Example 20 includes the system of any of examples 1-27, further comprising a particle speed detection system in communication with the data processing system and configured to measure a speed or velocity parameter of the individual particles during flow in the particle-flow channel, wherein the data processing system is configured to process the measured speed or velocity parameter with the obtained image data, the particle speed detection system comprising: a light-emitting diode (LED) light source configured to provide a LED light to pass through an individual particle during flow in the channel; a second spatial mask of the one or more spatial masks including two or more parallel slits arranged perpendicular to the flow direction; and a second optical detector of the one or more optical detectors, wherein the LED light that has passed through the individual particle subsequently passes through the second spatial mask before reaching the second optical detector to produce a photocurrent indicative of a travelling speed of the individual particle flowing in the particle-flow channel.

Example 21 includes the system of example 20 or any of examples 1-27, wherein the two or more parallel slits of the second spatial mask includes two slits separated by a slit distance, and wherein the travelling speed of the individual particle is determined by dividing the slit distance with a magnification factor and a time difference between a minima in the LED transmission signal.

Example 22 includes the system of example 21 or any of examples 1-27, wherein the two slits include 1 mm×10 μm slits separated by the slit distance of 200 μm.

Example 23 includes the system of any of examples 1-27, wherein the data processing system is configured to remove side lobe energy in the image data based on a protocol comprising: receive or format the image data in an image data set that comprises a plurality of two-dimensional (2D) scanned image slices; produce a deconvolution function based on a magnitude of one or more side lobes in a Bessel-Gaussian function; and produce a data set corresponding to the individual particle with side lobe energy removed by applying the deconvolution function to the plurality of 2D scanned image slices.

Example 24 includes the system of example 23 or any of examples 1-27, wherein the produced data set includes a 2D-filtered image data set.

Example 25 includes the system of any of examples 1-27, wherein the particles include at least one of non-living particles or living particles.

Example 26 includes the system of any of examples 1-27, wherein the living particles include living cells.

Example 27 includes the system of any of examples 1-26, wherein the non-living particles include beads.

In some embodiments in accordance with the present technology (example 28), a method for sorting particles includes modifying a shape of an excitation laser beam generated by a laser light source to produce a shape-modified excitation beam; directing the shape-modified excitation beam at a channel of a particle flow device; obtaining image data of individual particles flowing in a carrier fluid along the channel of the particle flow device by scanning the shape-modified excitation beam directed at the channel; processing the obtained image data to determine one or more properties associated with the individual particles flowing in the carrier fluid; producing a control command based on a comparison of the determined one or more properties with a sorting criteria, wherein the control command is produced in real time during the flowing of the individual particles in the channel; and sorting the individual particles based on the control command into one of a plurality of output directions branching from an input direction of the individual particles.

Example 29 includes the method of any of examples 28-35, further comprising analyzing, in real time during the flowing of the individual particles in the channel, the determined one or more properties to produce a sorting decision based on one or more attributes of the individual particles ascertained from the image data, wherein the produced control command is indicative of the sorting decision.

Example 30 includes the method of any of examples 28-35, wherein the sorting criteria includes one or more threshold properties of a particle corresponding to one or more of (i) an amount and/or a size of a sub-feature of or on an individual particle; (ii) an amount and/or size of the individual particle itself; (iii) a morphology characteristic of the sub-feature of the individual particle; or (iv) a morphological characteristic of the individual particle itself.

Example 31 includes the method of example 30 or any of examples 28-35, wherein the sorting criteria is predetermined, and wherein the data processing system is in communication with a remote computing device to receive a programmable command to adjust the sorting criteria from the client device.

Example 32 includes the method of any of examples 28-35, wherein the shape-modified excitation beam is a Bessel-Gaussian beam.

Example 33 includes the method of example 32 or any of examples 28-35, wherein the Bessel-Gaussian beam improves a focal depth of the individual particles in the obtained image data by 80% to 95% with respect to a Gaussian excitation laser beam.

Example 34 includes the method of any of examples 28-35, further comprising removing side lobe energy in the image data by receiving or formatting the image data in an image data set that comprises a plurality of two-dimensional (2D) scanned image slices; producing a deconvolution function based on a magnitude of at least one side lobe in a Bessel-Gaussian function; and producing a data set corresponding to the individual particle with side lobe energy removed by applying the deconvolution function to the plurality of 2D scanned image slices.

Example 35 includes the method of any of examples 28-34, wherein the method is implementable on the system of any of examples 1-27.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

1. An image-based particle sorting system, comprising:
an optical imaging system, including (i) a light source to produce an excitation beam, (ii) an optical shape-forming device to modify a shape of the excitation beam to have an increased focal depth that is to be directed at an interrogation area of a particle-flow channel, (iii) an optical scanning device to scan for one or more light beams at the interrogation area, (iv) one or more spatial filters arranged in an optical path of the directed shape-modified excitation beam, and (v) one or more optical detectors to obtain image data of individual particles flowing in a carrier fluid through the interrogation area of the particle flow device from the one or more scanned light beams;
a data processing system comprising at least one processor and at least one memory and in communication with the optical imaging system and configured to process the image data obtained by the optical imaging device to determine one or more properties associated with the individual particles flowing in the carrier fluid and to produce a control command based on a comparison of the determined one or more properties with a sorting criteria, wherein the control command is produced in real time during flowing of the individual particles in the particle-flow channel; and
a particle sorting system in communication with the data processing system and disposed in the optical path of the optical imaging system, the particle sorting system including a particle flow device and an actuator device operably coupled to the particle flow device, wherein the particle flow device comprises a substrate including the particle-flow channel and a plurality of output channels branching from the particle-flow channel to receive, in one output channel of the plurality of output channels, sorted particles directed by the actuator device based on the control command.

2. The system of claim 1, wherein the control command produced by the data processing system in real time is indicative of a sorting decision created in real time based on one or more attributes of the individual particles ascertained from the image data.

3. The system of claim 1, wherein the sorting criteria includes one or more threshold properties of a particle corresponding to one or more of (i) an amount and/or a size of a sub-feature of or on an individual particle; (ii) an amount and/or size of the individual particle itself; (iii) a morphology characteristic of the sub-feature of the individual particle; or (iv) a morphological characteristic of the individual particle itself.

4. The system of claim 3, wherein the sorting criteria is predetermined, and wherein the data processing system is in communication with a remote computing device to receive a programmable command to adjust the sorting criteria from the client device.

5. The system of claim 1, wherein the shape-modified excitation beam is a Bessel-Gaussian beam, and wherein the Bessel-Gaussian beam has an increased focal depth of the individual particles in the obtained image data by 80% to 95% with respect to a Gaussian excitation laser beam.

6. (canceled)

7. The system of claim 1, wherein the particle flow device includes a microfluidic chip.

8. The system of claim 1, wherein the actuator device includes a piezoelectric actuator.

9. The system of claim 1, wherein the optical shape-forming device includes an axicon.

10. The system of claim 1, wherein the light source includes a laser.

11. (canceled)

12. The system of claim 10, wherein the optical scanning device includes an acousto-optic deflector (AOD).

13. The system of claim 12, wherein the one or more optical detectors includes a photomultiplier tube (PMT) detector.

14. The system of claim 13, wherein the spatial mask includes a first spatial mask having one slit, and wherein the data processing system is configured to encode a two-dimensional transmission profile of an individual particle obtained from the PMT detector into a temporal signal capable of being compared to the sorting criteria such that the individual particle is by the actuator device based on the control command.

15. The system of claim 14, wherein the first spatial mask includes one slit, and wherein the first spatial mask is disposed at an image plane such that the one slit is aligned to the center of a Bessel-Gaussian beam to create an imaging area at a focal plane, wherein the first spatial mask is operable to block sidelobes of the Bessel-Gaussian beam along a flow direction of the individual particle while the sidelobes along a scanning direction perpendicular to the flow direction are able to pass the first spatial mask.

16. The system of claim 15, wherein the one slit of the first spatial mask includes a 500 μm×15 μm slit, and wherein the imaging area at the focal plane is created to be a 50 μm×1.5 μm area.

17. The system of claim 1, wherein the optical imaging system further includes one or more optical components to direct and/or manipulate the excitation beam in the optical path at the interrogation area of the particle-flow channel of the particle flow device.

18. The system of claim 17, wherein the one or more optical components to direct and/or manipulate light include one or more lenses, one or more mirrors, one or more dichroic mirrors, and one or more objective lenses.

19. The system of claim 18, wherein the one or more objective lenses include one or both of an illumination objective lens (IL) and a detection objective lens (DL).

20. The system of claim 1, further comprising:
a particle speed detection system in communication with the data processing system and configured to measure a speed or velocity parameter of the individual particles during flow in the particle-flow channel, wherein the data processing system is configured to process the measured speed or velocity parameter with the obtained image data, the particle speed detection system comprising:
a light-emitting diode (LED) light source configured to provide a LED light to pass through an individual particle during flow in the channel;
a second spatial mask of the one or more spatial masks including two or more parallel slits arranged perpendicular to the flow direction; and
a second optical detector of the one or more optical detectors,
wherein the LED light that has passed through the individual particle subsequently passes through the second spatial mask before reaching the second optical detector to produce a photocurrent indicative of a travelling speed of the individual particle flowing in the particle-flow channel.

21. The system of claim 20, wherein the two or more parallel slits of the second spatial mask includes two slits separated by a slit distance, and wherein the travelling speed of the individual particle is determined by dividing the slit distance with a magnification factor and a time difference between a minima in the LED transmission signal.

22. The system of claim 21, wherein the two slits include 1 mm×10 μm slits separated by the slit distance of 200 μm.

23. The system of claim 1, wherein the data processing system is configured to remove side lobe energy in the image data based on a protocol comprising:
receive or format the image data in an image data set that comprises a plurality of two-dimensional (2D) scanned image slices;
produce a deconvolution function based on a magnitude of one or more side lobes in a Bessel-Gaussian function; and
produce a data set corresponding to the individual particle with side lobe energy removed by applying the deconvolution function to the plurality of 2D scanned image slices.

24. The system of claim 23, wherein the produced data set includes a 2D-filtered image data set.

25. The system of claim 1, wherein the particles include at least one of non-living particles or living particles.

26. (canceled)

27. (canceled)

28. A method for sorting particles, comprising:
modifying a shape of an excitation laser beam generated by a laser light source to produce a shape-modified excitation beam;
directing the shape-modified excitation beam at a channel of a particle flow device;
obtaining image data of individual particles flowing in a carrier fluid along the channel of the particle flow device by scanning the shape-modified excitation beam directed at the channel;
processing the obtained image data to determine one or more properties associated with the individual particles flowing in the carrier fluid;
producing a control command based on a comparison of the determined one or more properties with a sorting criteria, wherein the control command is produced in real time during the flowing of the individual particles in the channel; and
sorting the individual particles based on the control command into one of a plurality of output directions branching from an input direction of the individual particles.

29. The method of claim 28, further comprising:
analyzing, in real time during the flowing of the individual particles in the channel, the determined one or more properties to produce a sorting decision based on one or more attributes of the individual particles ascertained from the image data, wherein the produced control command is indicative of the sorting decision.

30. The method of claim 28, wherein the sorting criteria includes one or more threshold properties of a particle corresponding to one or more of (i) an amount and/or a size of a sub-feature of or on an individual particle; (ii) an amount and/or size of the individual particle itself; (iii) a morphology characteristic of the sub-feature of the individual particle; or (iv) a morphological characteristic of the individual particle itself.

31. The method of claim 30, wherein the sorting criteria is predetermined, and wherein the data processing system is in communication with a remote computing device to receive a programmable command to adjust the sorting criteria from the client device.

32. The method of claim 28, wherein the shape-modified excitation beam is a Bessel-Gaussian beam.

33. The method of claim 32, wherein the Bessel-Gaussian beam improves a focal depth of the individual particles in the obtained image data by 80% to 95% with respect to a Gaussian excitation laser beam.

34. The method of claim 28, further comprising:
removing side lobe energy in the image data by receiving or formatting the image data in an image data set that comprises a plurality of two-dimensional (2D) scanned image slices;
producing a deconvolution function based on a magnitude of at least one side lobe in a Bessel-Gaussian function; and
producing a data set corresponding to the individual particle with side lobe energy removed by applying the deconvolution function to the plurality of 2D scanned image slices.

35. (canceled)
